(19) United States
(12) Patent Application Publication
(10) Pub. No.: US 2012/0136793 A1
(43) Pub. Date: May 31, 2012

(54) Method for connecting a human key identification to objects and content or identification, tracking, delivery, advertising, and marketing

(76) Inventors: David Valin, Flushing, NY (US); Alex Socolof, Briarcliff Manor, NY (US)

(21) Appl. No.: 13/360,670

(22) Filed: Jan. 28, 2012

Related U.S. Application Data
(63) Continuation of application No. 12/860,936, filed on Aug. 23, 2010, now abandoned.
Application No. 12/860,936 is a continuation of application No. 12/830,344, filed on Jul. 4, 2010.

(51) Int. Cl. G06Q 20/40; G06F 21/00; G06F 21/22; G06F 21/20

(52) U.S. Cl. 705/53; 705/52; 705/76; 705/59

(57) ABSTRACT

A method for connecting a human key identification to objects and content or identification, tracking, delivery, advertising, and marketing. An Independent Clearing House Agent (ICHA) server is connected to a human key server. The human key server is connected to a translation server and universal virtual world (UVW) server for the management of a plurality of methods and device integrally working as one system. A virtual world airport (VWA) server is connected to a Mobile, Handheld, and Independent Device Application Development (MHIDAD) server which in turn communicates with an illumination transformer audio video manager interactive server transmitter (ITAVMIST which communicates with a virtual cash virtual currency (VCVC) server. The authentication unit also creating identification data; and sending to verification; a match combined with 9 out of 17 positive point evaluations returns, via an Internet connection to the mobile device.

### CROSS REFERENCE TO RELATED APPLICATIONS

This application claims priority from and is a Continuation of U.S. patent application Ser. No. 12/860,936, entitled “Apparatus for connecting Protect Anything Human key identification device to objects, content, and virtual currency for identification, tracking, delivery, advertising and marketing”, filed on Aug. 23, 2010, which is incorporated by reference in its entirety for all purposes as if fully set forth herein.

U.S. patent application Ser. No. 12/860,936 is a Continuation of U.S. patent application Ser. No. 12/830,344 entitled “Apparatus for secure recording and transformation of images to light for identification, and audio visual projection spatial point targeted area” filed on Jul. 4, 2010

### SEQUENCE LISTING OR PROGRAM

Not Applicable

### FEDERALLY SPONSORED RESEARCH

Not Applicable

### TECHNICAL FIELD OF THE INVENTION

The present invention generally relates to a method for indemnifying and protecting information. More specifically the present invention relates a method of identifying and authenticating a user's identity and transmitting protected information to the identified and authenticated user.

### BACKGROUND OF THE INVENTION

The ways in which someone may be authenticated fall into three categories, based on what are known as the factors of authentication: something a user know, something a user have, or something a user are. Each authentication factor covers a range of elements used to authenticate or verify a person's identity prior to being granted access, approving a transaction request, signing a document or other work product, granting authority to others, and establishing a chain of authority.

Security research has determined that for a positive identification, elements from at least two, and preferably all three, factors be verified. The three factors (classes) and some of elements of each factor are: the ownership factors: something the user has (e.g., wrist band, ID card, security token, software token, phone, or cell phone); the knowledge factors: something the user knows (e.g., a password, pass phrase, or personal identification number (PIN), challenge response (the user must answer a question)); and the inherence factors: something the user is or does (e.g., fingerprint, retinal pattern, DNA sequence (there are assorted definitions of what is sufficient), signature, face, voice, unique bio-electric signals, or other biometric identifier).

When elements representing two factors are required for identification, the term two-factor authentication is applied. E.g. a bankcard (something the user has) and a PIN (something the user knows). Business networks may require users to provide a password (knowledge factor) and a pseudorandom number from a security token (ownership factor). Access to a very high security system might require a mantrap screening of height, weight, facial, and fingerprint checks (several inherence factor elements) plus a PIN and a day code (knowledge factor elements), but this is still a two-factor authentication.

Counterfeit products are often offered to consumers as being authentic. Counterfeit consumer goods such as electronics, music, apparel, and counterfeit medications have been sold as being legitimate. Efforts to control the supply chain and educate consumers to evaluate the packaging and labeling help ensure that authentic products are sold and used. Even security printing on packages, labels, and nameplates, however, is subject to counterfeiting.

One familiar use of authentication and authorization is access control. A computer system that is supposed to be used only by those authorized must attempt to detect and exclude the unauthorized. Access to it is therefore usually controlled by insisting on an authentication procedure to establish with some degree of confidence the identity of the user, granting privileges established for that identity. Common examples of access control involving authentication include: Asking for photoID when a contractor first arrives at a house to perform work; Using captcha as a means of asserting that a user is a human being and not a computer program; A computer program using a blind credential to authenticate to another program; Logging in to a computer; Using a confirmation E-mail to verify ownership of an e-mail address; Using an Internet banking system; and Withdrawing cash from an ATM.

In some cases, ease of access is balanced against the strictness of access checks. For example, the credit card network does not require a personal identification number for authentication of the claimed identity; and a small transaction usually does not even require a signature of the authenticated person for proof of authorization of the transaction. The security of the system is maintained by limiting distribution of credit card numbers, and by the threat of punishment for fraud.

Security experts argue that it is impossible to prove the identity of a computer user with absolute certainty. It is only possible to apply one or more tests which, if passed, have been previously declared to be sufficient to proceed. The problem is to determine which tests are sufficient, and many such are inadequate. Any given test can be spoofed one way or another, with varying degrees of difficulty.

Therefore, what is needed is a method and apparatus for proving identity of a computer or other electronic device user by applying one or more tests which are sufficient to proceed with allowing access and which are adequate in certainty of identity of a user.

### Definitions

A “human key” is a software identification file that enables a user to verify themselves to another user or a computer system. The software file of the human key enables a user to be verified and/or authenticated in a transaction and also provides tracking of the financial transaction by associating the transaction to one or more human keys which identify and authenticate a user in the system.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

A “mobile device” is a generic term used to refer to a variety of devices that allow people to access data and information from where ever they are. This includes cell phones and other portable devices such as, but not limited to, PDAs, Pads, smartphones, and laptop computers.

“Netbot” is an automated or semi-automated tool that can carry out repetitive and mundane tasks.

“NFC” is an acronym for “Near Field Communication” which allows for simplified transactions, data exchange, and wireless connections between two devices in proximity to each other, usually by no more than a few centimeters. NFC is expected to become a widely used system for making payments by smartphone in the United States. Many smartphones currently on the market already contain embedded NFC chips that can send encrypted data a short distance (“near field”) to a reader located, for instance, next to a retail cash register. Shoppers who have their credit card information stored in their NFC smartphones can pay for purchases by waving their smartphones near or tapping them on the reader, rather than using the actual credit card.

“Social network sites” are web-based services that allow individuals to (1) construct a public or semi-public profile within a bounded system, (2) articulate a list of other users with whom they share a connection, and (3) view and traverse their list of connections and those made by others within the system. The nature and nomenclature of these connections may vary from site to site. While we use the terms “social network”, “social network pages”, and “social network site” to describe this phenomenon, the term “social networking sites” also appears in public discourse, and the variation of terms are often used interchangeably.

### SUMMARY OF THE INVENTION

The current present invention is a method for connecting a human key identification to objects and content or identification, tracking, delivery, advertising, and marketing. A plurality devices integrally working as one system is explained. An Independent Clearing House Agent (ICHA) server is connected to a human key server. The human key server is connected to a translation server and universal virtual world (UVW) server for the management of a plurality of methods and device integrally working as one system. A virtual world airport (VWA) server is connected to a Mobile, Handheld, and Independent Device Application Development (MHIDAD) server which in turn communicates with an illumination transformer audio video manager interactive server transmitter (ITAVMIST which communicates with a virtual cash virtual currency (VCVC) server. The authentication unit also creating identification data; and sending to verification; a match combined with 9 out of 17 positive point evaluations returns, via an Internet connection to the mobile device.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a method for connecting a human key identification to objects;

FIG. 2 illustrates an IP Property method used in human key method;

FIG. 3 illustrates Imaging, Matching Contributions, Sports, and Dating methods;

FIG. 4 illustrates human key Widget and Standard user interface methods;

FIG. 5 illustrates a Virtual World tracking, recording, paying and listing method;

FIG. 6 illustrates a human key Audio Video Fingerprint Identification System;

FIG. 7 illustrates a human key 3D Identification Dual 3D H3DVARVP Cam Method;

FIG. 8 illustrates a human key 3D Audio Video method with H3DVARVP 3D Human Video Audio Stereo Viewing and Recording method with Color Band Encryption De-Encryption Security System;

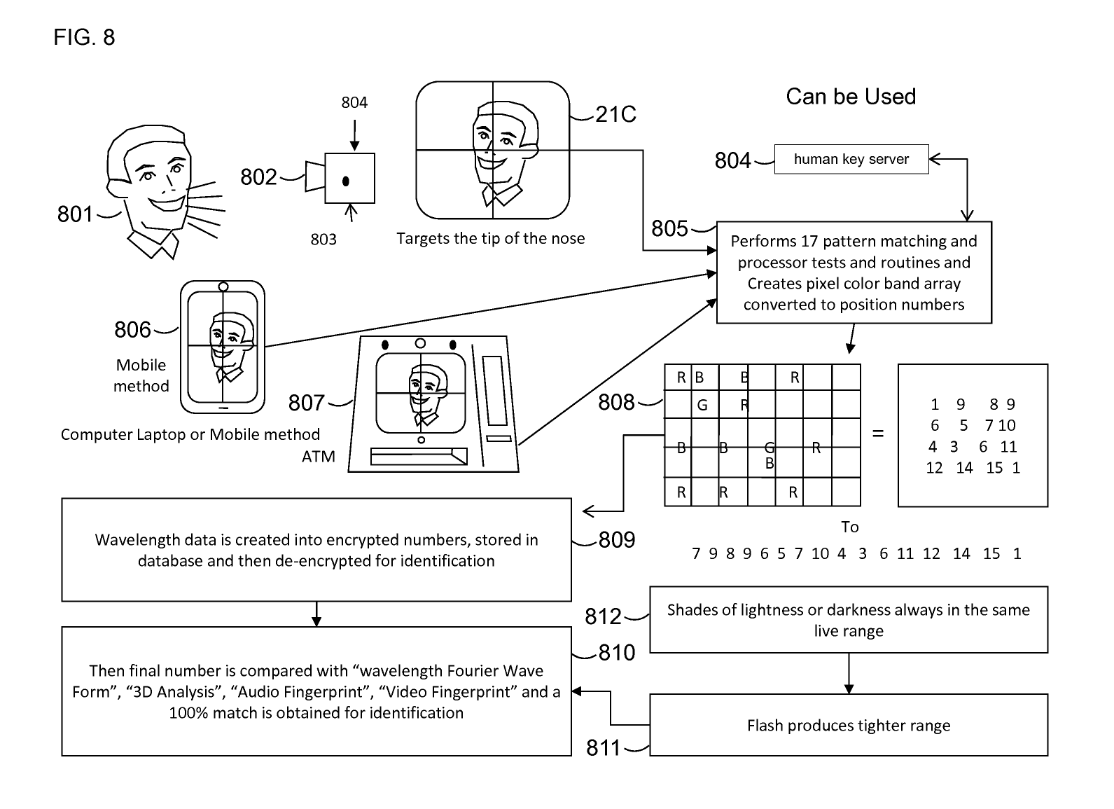

FIG. 9 illustrates a human key identification processor method;

FIG. 10 illustrates a Speaking and publishing storage and distribution method with human key method;

FIG. 11 illustrates an Indexing Engine method;

FIG. 12 illustrates a human key method Connected to a Sense System;

FIG. 13 illustrates human key Product Identification and registry method Engine;

FIG. 14 illustrates Open Source Clearing House Software method in Virtual and Non Virtual World;

FIG. 15 illustrates a human key attached to property rights management method;

FIG. 16 illustrates a Virtual and Non Virtual World Idea Testing method, and Vault method;

FIG. 17 illustrates a Phrase Analysis and Recognition method;

FIG. 18 illustrates Virtual World Real Estate Agency, Objects registry, Store Front Creator methods;

FIG. 19 illustrates a Virtual World Creditor, Credit Score, Bank Account methods;

FIG. 20 illustrates a Solar panel wind turbine communication server appliance node network infrared laser light waves transformed to audio sound waves with ITAVMIST and Human key at spatial point target zone;

FIG. 21 illustrates human key additional multiple encryption audio single words, numbers, music, tones, phrases, human gestures, smells, tastes, symbols, authentication method;

FIG. 22 illustrates an Illumination Transformer Audio Video Manager Interactive Server Transmitter (ITAVMIST) virtual credits and debits method;

FIG. 23 illustrates a Virtual and Non Virtual World Product, Content Registry method;

FIG. 24 illustrates Illumination Transformer Audio Video Manager Interactive Server Transmitter (ITAVMIST) creations, licensing and attaching human key to intellectual property method;

FIG. 25 illustrates an Illumination Transformer Audio Video Manager Interactive Server Transmitter (ITAVMIST) infrared topographical pixel distance determination facial object, human key method;

FIG. 26 illustrates a Virtual and Non Virtual World Talent Registry, Funding, Applications Management method;

FIG. 27 illustrates an Illumination Transformer Audio Video Manager Interactive Server Transmitter (ITAVMIST), human key Virtual and Non Virtual World Registry method;

FIG. 28 illustrates a Virtual World Biography, Reputation, Medical, Dating and Verification method;

FIG. 29 illustrates an Illumination Transformer Audio Video Manager Interactive Server Transmitter (ITAVMIST) Video Laser Scan Free Space Projection Targeted to Spatial Point Targets method;

FIG. 30 illustrates a human key attached to News, Movie stars, Celebrities, and Talent Agency method;

FIG. 31 illustrates an Illumination Transformer Audio Video Manager Interactive Server Transmitter (ITAVMIST) Audio Video Free Space Projection Targeted to Spatial Point Targets method;

FIG. 32 illustrates an Illumination Transformer Audio Video Manager Interactive Server Transmitter (ITAVMIST) Audio Video Credit Card System “a user are the Card” with “Human key” method;

FIG. 33 illustrates a Virtual World, Virtual Cash, KWH Bank, Energy bank, Idea Bank, Content bank method;

FIG. 34 illustrates a Illumination Transformer Audio Video Manager Interactive Server Transmitter (ITAVMIST) Stereo 3D infrared pixel point facial distance, audio voice print identification method;

FIG. 35 illustrates an Illumination Transformer Audio Video Manager Interactive Server Transmitter (ITAVMIST) multiple people using multiple different size screens for viewing in their own zone method;

FIG. 36 illustrates Advertising, renting, loans, currency, admissions, and franchise Virtual Cash method;

FIG. 37 illustrates a Virtual News, Promotions, Advertising in Virtual Cash method;

FIG. 38 illustrates a Virtual Stores, Collaborations, Virtual Loans in Virtual Cash method;

FIG. 39 illustrates a Protect, ITAVMIST, Clearing House, Applications, and Virtual Cash method;

FIG. 40 illustrates a Virtual World Content handling processor method;

FIG. 41 illustrates a Translate Fourier transformation method;

FIG. 42 illustrates a Laser Transmitter Receiver transmit scanning method

FIG. 43 illustrates a Collaborate Search Engine (CASE) method; and

FIG. 44 is an illustration representative showing the Illumination Transformer Audio Video Manager Interactive Server Transmitter (ITAVMIST-IL-UHD) Ultra High Definition Multi Spectrum.

### DETAILED DESCRIPTION OF THE INVENTION

In the following detailed description, reference will be made to the accompanying drawings, in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The current present invention is a method for connecting a human key identification to objects and content or identification, tracking, delivery, advertising, and marketing. The method is for people who want to help, or invest in, people and causes or businesses who want to advertise on targeted areas of the website portals of the computers executing and enabling the method of the present invention. Those looking to adopt (adopters) surf all the campaigns, View history statistics of campaigns, Subscribe to a campaign to watch, Invest in a campaign, Create a Loan for a campaign, Contribute to a campaign, Promote a campaign, Email a campaign, Place a desired campaign in wanted list in a computer system executing and enabling the present invention.

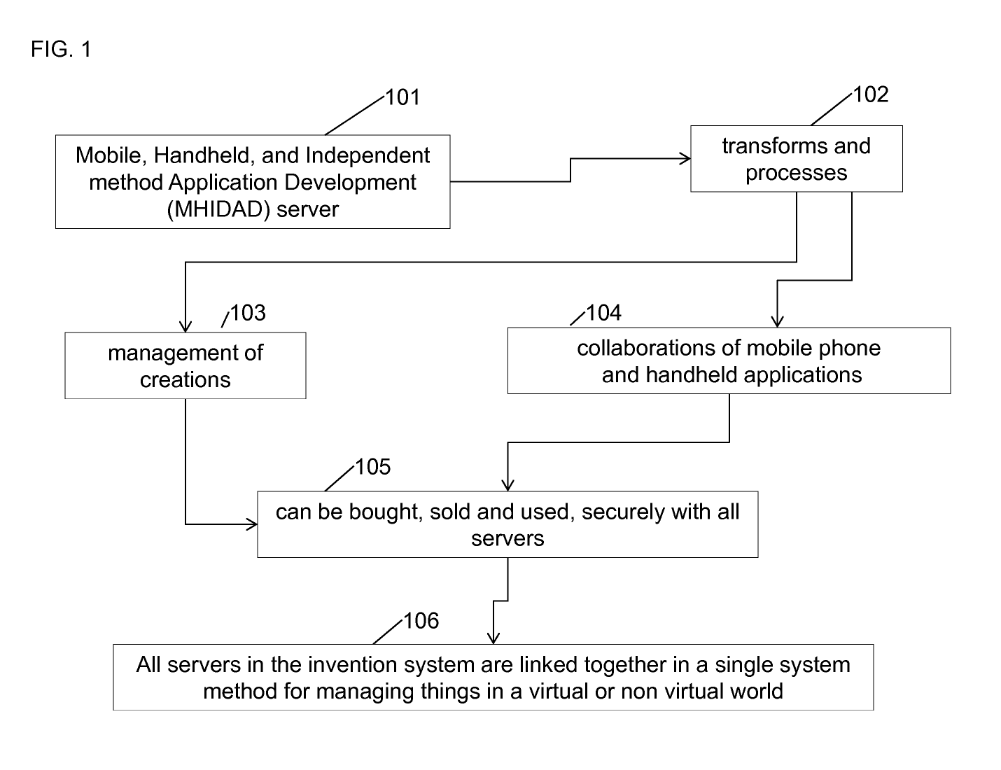

Now referring to FIG. 1, Mobile, Handheld, and Independent Device Application Development (MHIDAD) servers 101 transform and process information 102 and manage content creations 103 and collaboration of mobile phones and handheld applications 104 that can be bought, sold, or used securely within all servers 105. All servers in the invention system are linked together in a single system for managing property in a virtual or non virtual world 106.

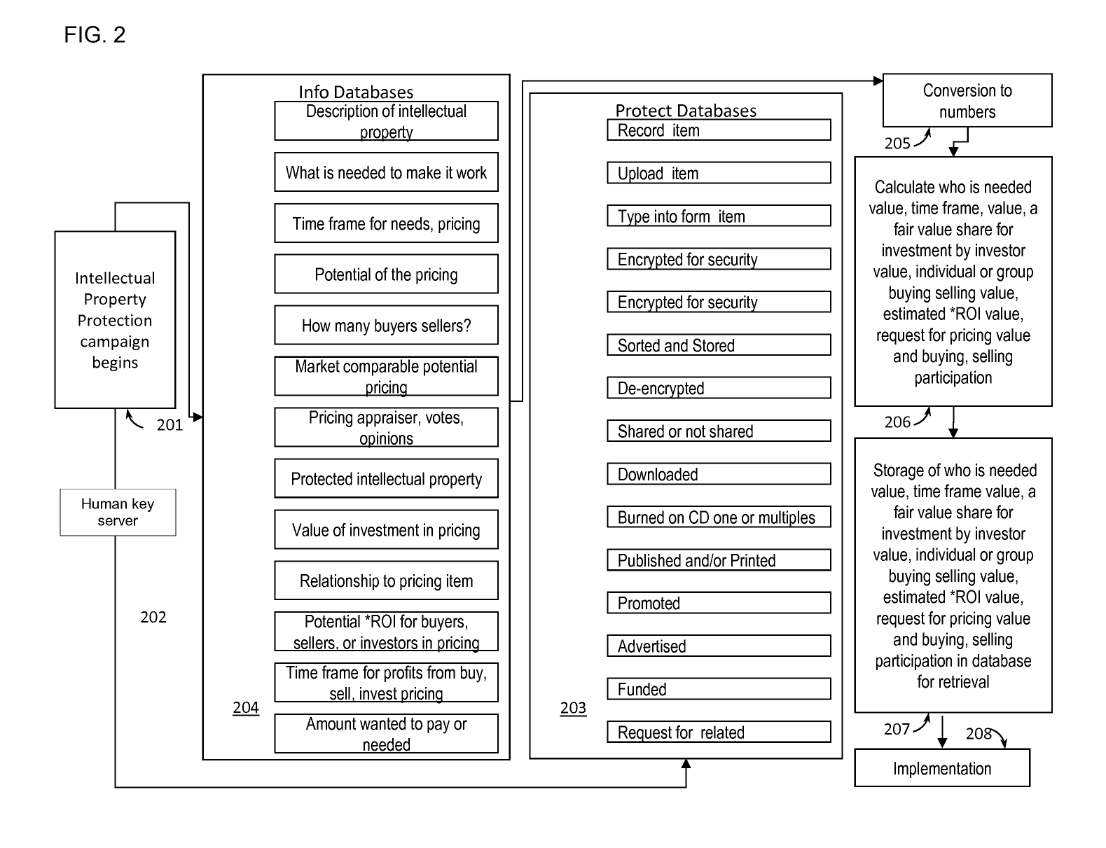

Now referring to FIG. 2, the method of IP property protection using a human key in a virtual and non-virtual world is illustrated. First an Intellectual Property Protection campaign begins 201. The human key server 202 provides authentication and identification services to the campaign started in step 201 by accessing protection databases 203. Upon beginning a campaign, information databases 204 are accessed and a conversion of the campaign into a numerical valuation begins 205. The process then proceeds to calculate who is needed value, time frame, value, a fair value share for investment by investor value, individual or group buying selling value, estimated ROI value, request for pricing value and buying, selling participation in step 206. This numerical determination is then stored in step 207 and implementation of the campaign begins 208.

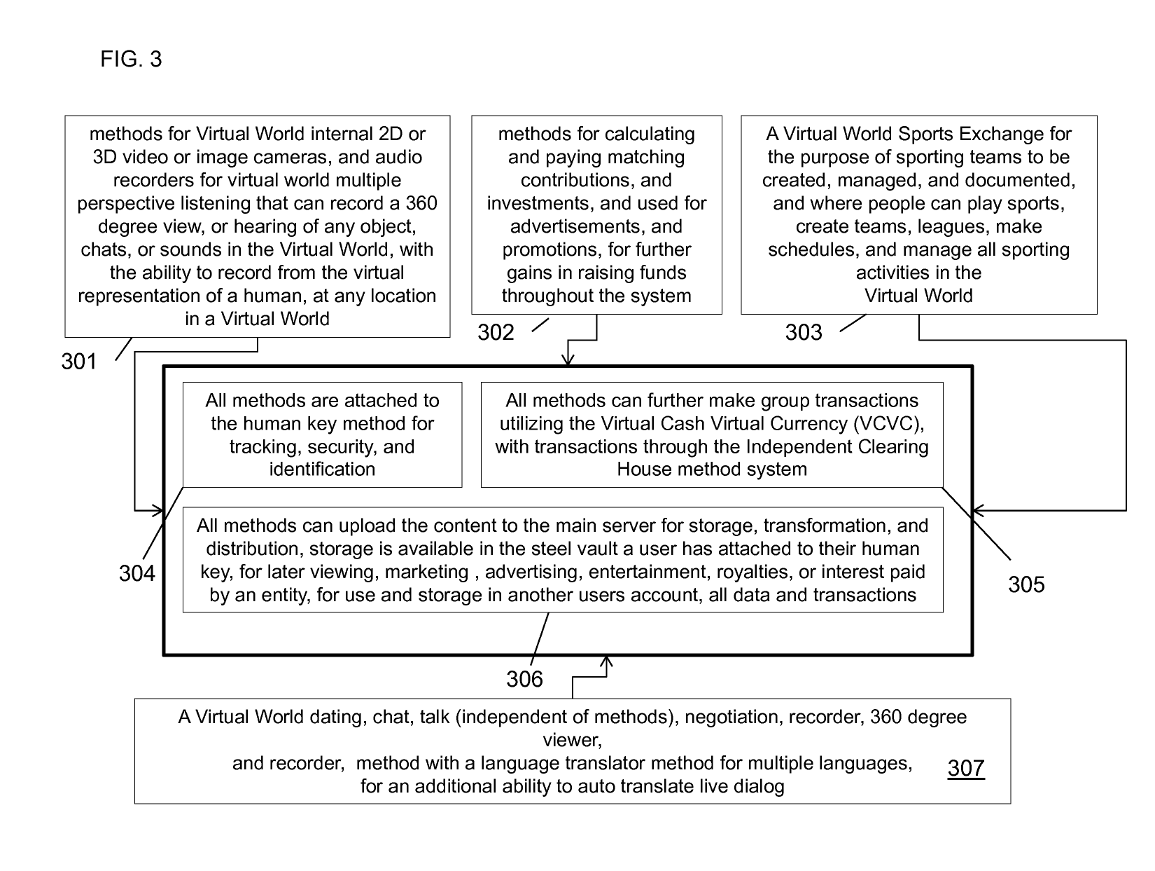

Now referring to FIG. 3, the method for imaging and matching contributions is shown. Device for Virtual World internal 2D or 3D video or image cameras, and audio recorders for virtual world multiple perspective listening that can record a 360 degree view, or hearing of any object, chats, or sounds in the Virtual World, with the ability to record from the virtual representation of a human, at any location in a Virtual World 301. Devices for calculating and paying matching contributions, and investments, and used for advertisements, and promotions, for further gains in raising funds throughout the system 302. A Virtual World Sports Exchange Devices for the purpose of sporting teams to be created, managed, and documented, and where people can play sports, create teams, leagues, make schedules, and manage all sporting activities in the Virtual World 303. All devices are attached to the human key device for tracking, security, and identification 304. All devices can further make group transactions utilizing the virtual cash virtual currency (VCVC), with transactions through the Independent Clearing House device system 305. All devices can upload the content to the main server for storage, transformation, and distribution, storage is available in the steel vault a user has attached to their human key, for later viewing, marketing, advertising, entertainment, royalties, or interest paid by an entity, for use and storage in another user's account, all data and transactions 306. A Virtual World dating, chat, talk (independent of devices), negotiation, recorder, 360 degree viewer, and recorder, device with a language translator device for multiple languages, for an additional ability to auto translate live dialog 307.

Mobile Devices, Hand held Devices, Laptops, Tablets, and Phone devices working with other devices for the purposes of protecting, sharing journaling, paying, collaborating, authenticating, adopting, buying, selling, publicizing, advertising, storing, accessing, certifying, tracking, and editing in the virtual and non-virtual worlds of the present invention.

The method of the present invention teaches creating virtual vouchers, coupons, rebates, and discounts transacted with virtual cash virtual currency (VCVC) devices. Additionally, devices can be used for the purposes of tastings, sampling, promotions, advertising, and marketing, getting users into a place or store. Special trading device can be used for a simulated Virtual World IPO, going public, stock, options and derivative trading, buying multiple ideas and trading them in a blind pool of ideas, for what if scenarios, entertainment, planning and education. All devices are attached to the human key for tracking, security, and identification.

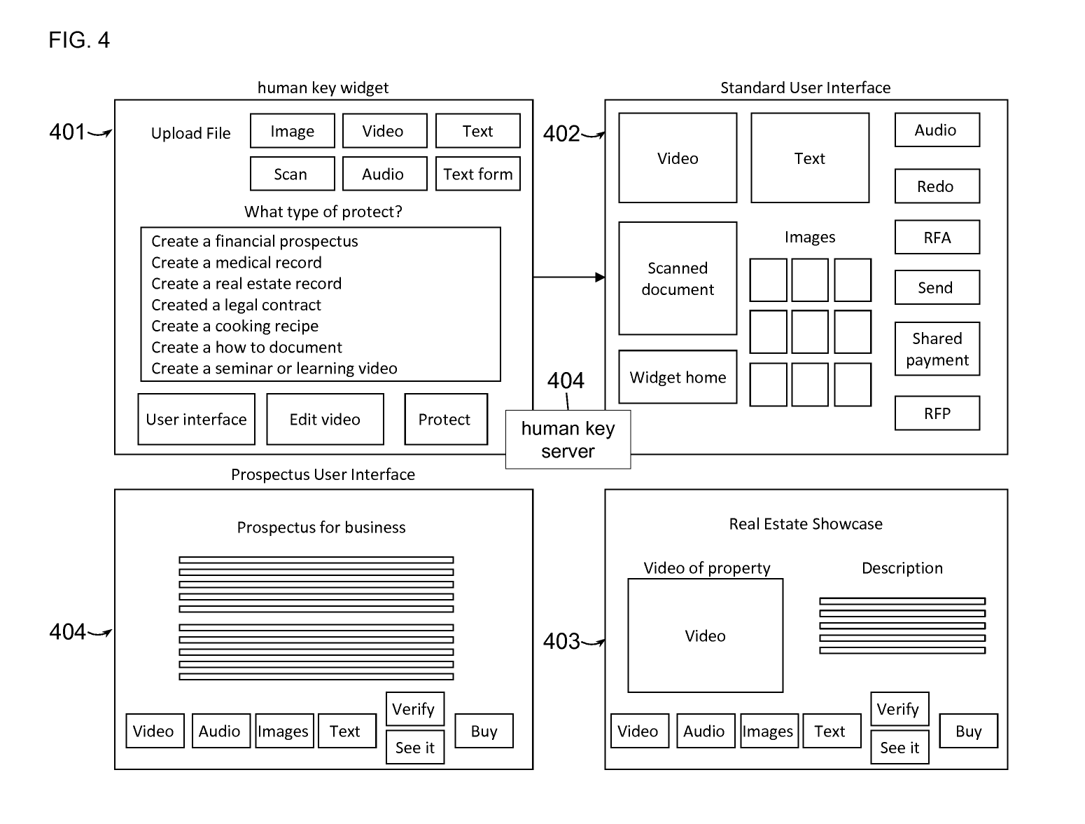

Now referring to FIG. 4, user interfaces on electronic devices for four different applications of the method of the present invention are shown. A human key display 401 provides for the uploading of various file types such as images, video, text, scans, audio, or forms. A user can also select from a list the type of property being entered into the system for protection. A standard user interface 402 provides access to video, text, documents, images, and audio while allowing the user to edit, or send information or payment within the system for various transactions. A real estate showcase 403 provides images or video of a property and a written description with links to additional video, audio, images, and text in addition to providing the ability to purchase the property. Finally, a prospectus user interface 404 provides a business prospectus for review by a user with links to additional video, audio, images, and text in addition to providing the ability to purchase the property. All displays are connected to the human key server 404 for identification and authentication of the information being present and all transactions performed.

In another embodiment, the method can be adapted to manage news, articles, and other content so that a user can create news, articles, and content, read news, articles, and content, buy, sell, trade, and barter, news, articles, and content, and a user can create a news, articles, and content transactions. A user can search for news, articles, and content pricing, and/or then upload, protect, market, and do bank transactions or use by the included smart intelligent agent device for devices, or other people to make transactions. All methods and devices attached to the human key device. All methods and devices utilizing virtual cash virtual currency (VCVC) for news, articles, and content, with a human management.

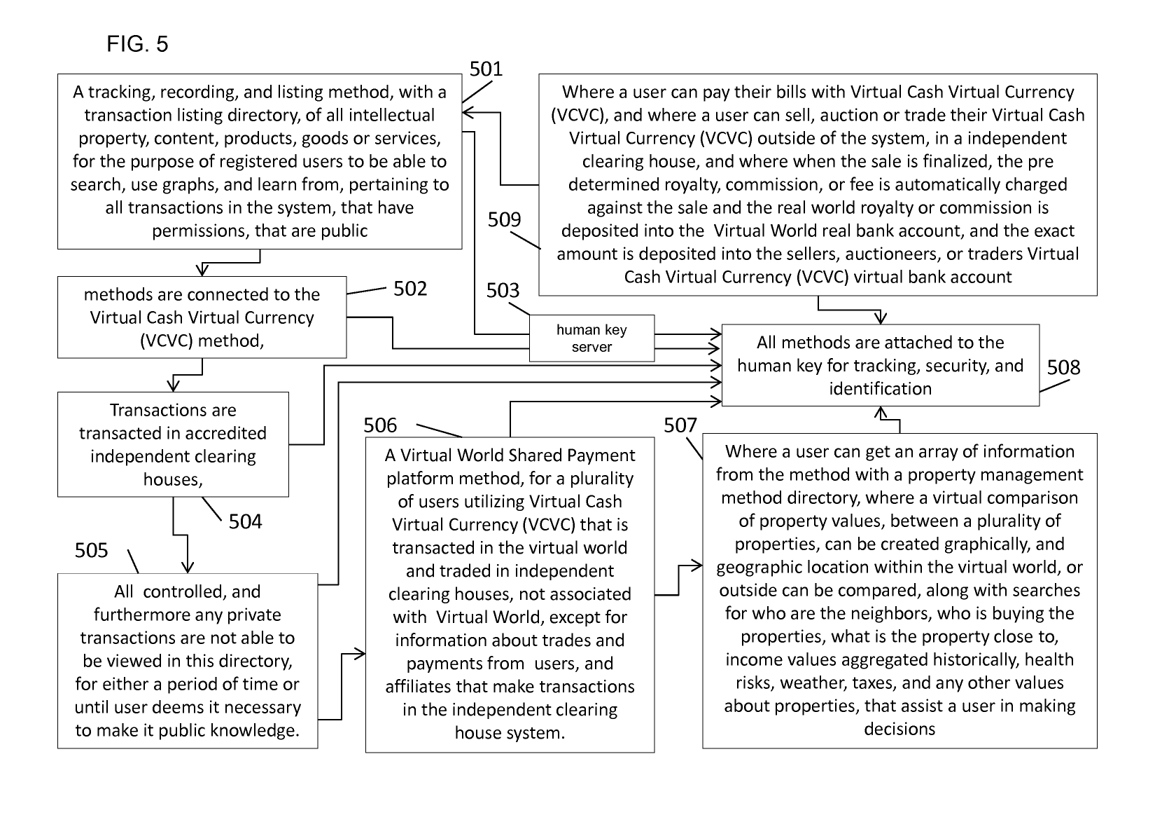

Now referring to FIG. 5, the tracking, recording, paying and listing device method of the present invention is shown. A tracking, recording, and listing device, with a transaction listing directory, of all intellectual property, content, products, goods or services, for the purpose of registered users to be able to search, use graphs, and learn from, pertaining to all transactions in the system, that have permissions, that are public 501. Devices are connected to the virtual cash virtual currency (VCVC) device 502, and human key server 503. Transactions are transacted in accredited independent clearing houses 504. All controlled, and furthermore any private transactions are not able to be viewed in this directory, for either a period of time or until user deems it necessary to make it public knowledge 505. A Virtual World Shared Payment platform device, for a plurality of users utilizing virtual cash virtual currency (VCVC) that is transacted in the virtual world and traded in independent clearing houses, not associated with Virtual World, except for information about trades and payments from users, and affiliates that make transactions in the independent clearing house system 506. Where a user can get an array of information from the device with a property management device directory, where a virtual comparison of property values, between a plurality of properties, can be created graphically, and geographic location within the virtual world, or outside can be compared, along with searches for who are the neighbors, who is buying the properties, what is the property close to, income values aggregated historically, health risks, weather, taxes, and any other values about properties, that assist a user in making decisions 507. All devices are attached to the human key 503 for tracking, security, and identification 508. A user can pay their bills with virtual cash virtual currency (VCVC), and where a user can sell, auction or trade their virtual cash virtual currency (VCVC) outside of the system, in an independent clearing house, and where when the sale is finalized, the pre-determined royalty, commission, or fee is automatically charged against the sale and the real world royalty or commission is deposited into the Virtual World real bank account, and the exact amount is deposited into the sellers, auctioneers, or traders virtual cash virtual currency (VCVC) virtual bank account 509.

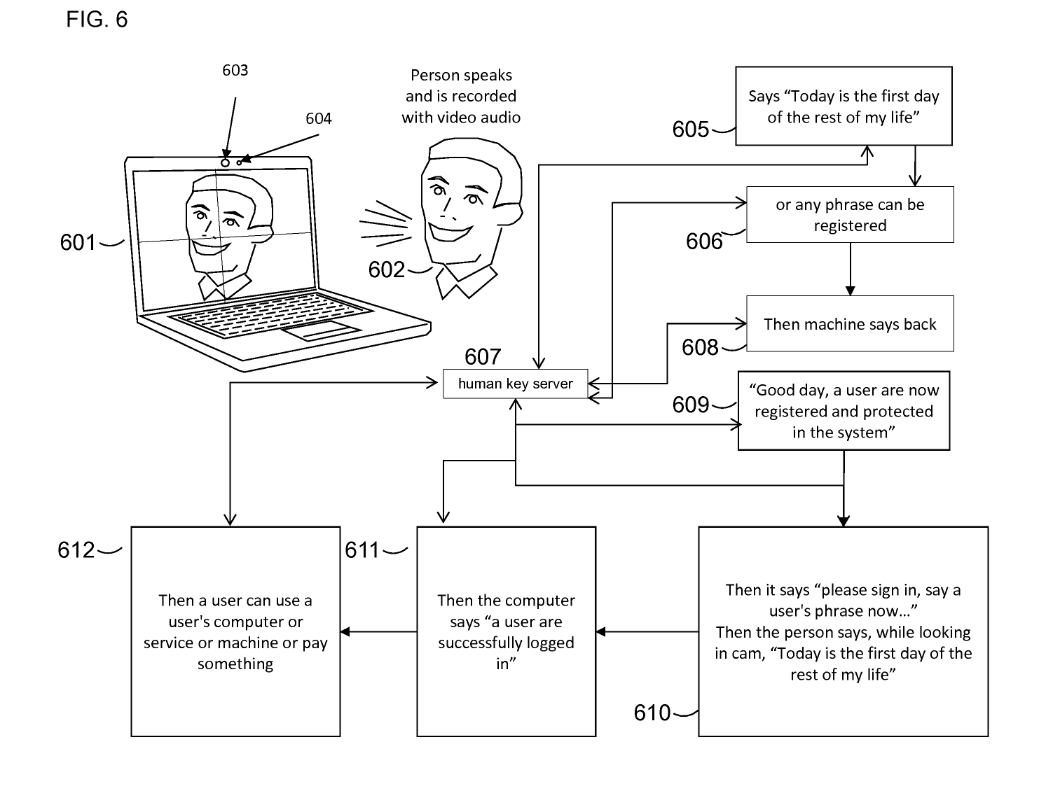

Now referring to FIG. 6, the human key audio video fingerprint identification process is shown. A user 602 first speaks and is recorded with video and audio into a laptop, smartphone, tablet computer, or other electronic device 601 that can record audio and video using a camera 603 and microphone 604. A phrase is spoken 605 and matched to a previously recorded phrase 606. The human key server 607 verifies the phrase and provides confirmation 608 by stating “Good day, a user are now registered and protected in the system” 609. Then it says “please sign in, say your phrase now . . . ” Then the person says, while looking in cam, “Today is the first day of the rest of my life” 610. Then the computer says “A user is successfully logged in” 611. Then a user can use your computer or service or machine or pay something 612.

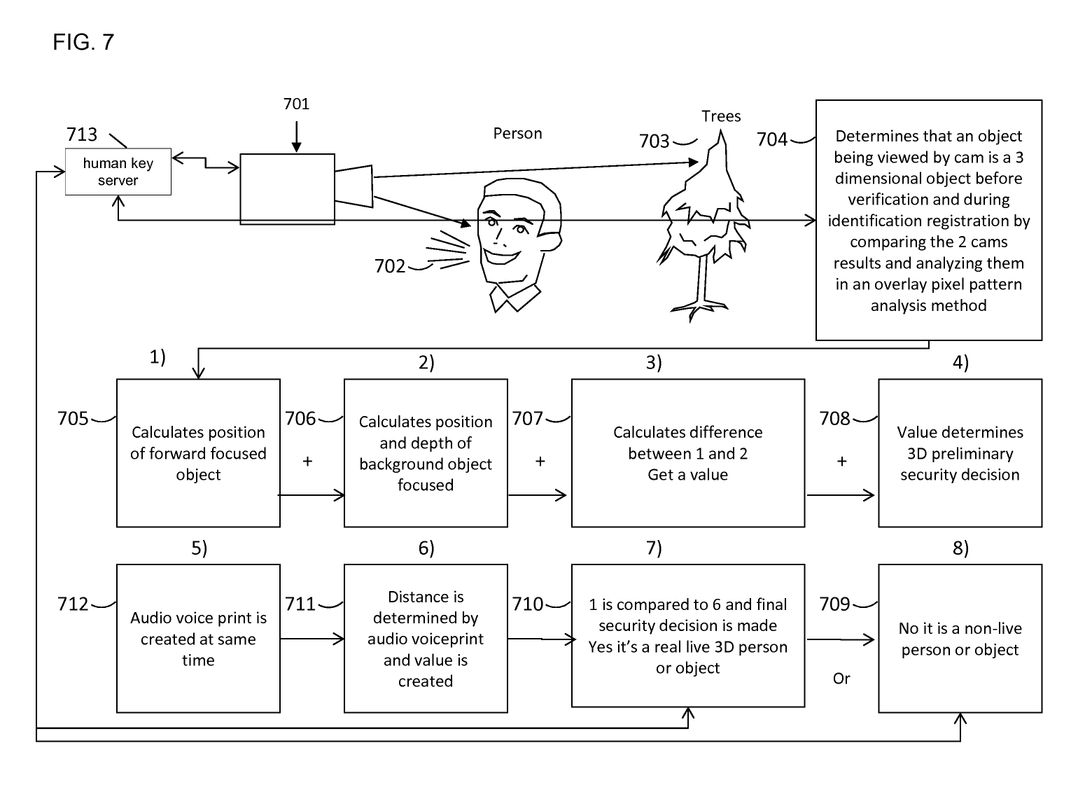

Now referring to FIG. 7, the method for human key 3D identification is shown. First a 3D camera 701 recording a person 702 and background images 703 determines that an object being viewed by cam is a 3 dimensional object before verification and during identification registration by comparing the 2 cams results and analyzing them in an overlay pixel pattern analysis method 704. The first step Calculates position of forward focused object 705. The next step Calculates position and depth of background object focused 706. The next step Calculates difference between 1 and 2 and determines a value 707. The Value determines 3D preliminary security decision 708. An Audio voice print is created at same time 712. Distance is determined by audio voiceprint and value is created 711. position of forward focused object 705 is compared to the Distance is determined by audio voiceprint 711 and final security decision is made 710, Yes it's a real live 3D person or object or No it is a non-live person or object 709. This information is then stored in the human key server 713.

In another embodiment of the present invention, the method from FIG. 7 can also be used for payment transactions where the person or individual is the credit card. In this embodiment the human key server collects 3D auto and video as described in FIG. 7 and then determines that the user is who was registered in system with a bank or other money holding system. Then person says “pay bill”, “pay”, or “get money” and the human key system knows who a user are with verification of 3D audio, 3D video, and phrase analysis, and 3D security test and “pays a bill” or “pays” online purchase or “gives cash at ATM”. Every time a user day “pay bill” or “pay” or “get money” the system learns from your voice print compared to your video print. Every time a user says “pay bill” or “pay” or “get money” the system learns from your voice print compared to your video print. The system has security human key chaotic event module for emergency needs. This method can be combined with PIN number, mobile dongle, or fingerprint retina scan technology.

In another embodiment, virtual cash currency can be used by the method and system of the present invention. Applications that are created by outside creators, have virtual cash virtual currency (VCVC) connections, and are charged a royalty fee for sales of applications. Properties built in the virtual cash virtual currency (VCVC) world have valuations attached to a human key, and valuations of the properties are updated periodically as traffic, interest, and viewers increase around that properties area, and at least one spot of the property, is required to be allocated for promotions and advertising. The only way to get virtual cash virtual currency (VCVC) in the device is by purchasing content, properties, objects, or services from a user that is registered with a royalty agreement in the system, and that purchase, gives the purchaser an equal amount of virtual cash virtual currency (VCVC) to the actual price paid at an independent clearing house. The virtual cash virtual currency (VCVC) is used for all promotions and advertising in the system, so for an advertiser to advertise in the system they need to purchase content from an outside clearing house and then the advertiser gets a specified amount of virtual cash virtual currency (VCVC) to use in the system. virtual cash virtual currency (VCVC) is paid to a registered user for any content added to the content bank, idea bank, or intellectual property bank, automatic promotions are added to the payment package for promoting sales, collaborations, reviews, and assistance with services, manufacturing, further promotions, editing, and packaging, transactions. All methods and devices are attached to the human key for tracking, security, and identification. To purchase anything in the system a user are required to have virtual cash virtual currency (VCVC) and when a user register in the system a virtual bank account is setup and websites, and virtual entry points can charge a certain amount of (VCVC) for a user to be able to enter. The virtual cash virtual currency (VCVC) is used in a listings guide for valuations of properties, content, objects, and entities, continuously in the system for immediate availability and value determination of properties.

The virtual cash virtual currency (VCVC) method and device is used for valuations of content uploaded into the system, and is displayed when content is stored, so that a work of art, writing, photograph, movie, video, song, idea gets a certain amount of virtual cash virtual currency (VCVC) when it is added to the system. A certain amount of royalties are automatically attached to the content, and attached to the human key for security, identification, tracking, and transactions. All content, and contracts dependent upon content are secured, attached, and signed by the user's human key, and cosigned by the virtual cash virtual currency (VCVC) Intelligent Virtual Private Currency Server node system device administrator human key. A Virtual World design center device, and Virtual creative lab device attached to the human key for architects, or want to be architects, and designers to create their designs, display them, transact them, find professional users to bring them to life, or just test them to see the validity of the design.

An applications store device for open source applications related to the virtual cash virtual currency (VCVC) virtual world device, for use with purchases made utilizing virtual cash virtual currency (VCVC) virtual world currency, in a virtual world or non virtual world, where a user can list, package, protect, request a sponsor, collaboration, sale or investor, market with shared advertising and revenue or promote is also taught by the present invention. Virtual World Payments, Currency, Money, Credit, Debit, Buying, Selling, protection, Privacy, Trading, and Barter can be done within a no charge to join, or a fee to join, system, where even smaller percentage is paid for rights on goods related to content indefinitely, so if a content is sold many times over the years, the system operators will continually get a percentage of every sale made for the content promoted in the virtual cash virtual currency (VCVC) device platform system. A percentage of the royalties paid when content is sold is paid to the system operators, and where a larger percentage if the sales royalties are a onetime rights sale, and smaller percentage is paid to the systems operators if royalty rights are charged for every sale of goods related to the content for a longer time such as 10 years. A virtual world bot agent for making automatic deals involving content in virtual world with attached human key universal wallet, that can work in any virtual world, or non virtual world wide web, buy additional promotion with virtual cash virtual currency (VCVC) virtual world currency where a virtual world transaction exchange, and management area for pricing content submitted, is provided in the system, and a universal tool kit for making designs for packaging, and creating virtual world contracts, is included in.

A Virtual World transaction exchange device attached to the human key device, for users to create, manage, and market transactions in the virtual world is also taught. Transactions can be uploaded to the real world and deals are controlled by users, and the system gets only a percentage of the deal made, unless another agreement is recorded for the transaction by the user(s) in the system. A Virtual World witness device attached to the human key device, for a user to have an authorized record for, check writing, check cashing, agreements, contracts, proposals, signing of documents, legal and medical transactions, procedure and records. A Virtual World Adopt Anything device attached to the human key device, for creating, managing and fulfilling Adopt Anything Campaigns, in a virtual or non virtual world. A Virtual World rights management device attached to the human key device, for content management of promotions, marketing, and collaboration needs, and rights can be paid with virtual cash virtual currency (VCVC). A Virtual World Resume device attached to the human key device for users to manage, upload, create, store, and distribute their resumes in video, text, image, or 3D virtual world projection, to any spatial point target, or virtual world space. A Virtual World Future Goods or Services device attached to a human key where a user(s) can list, shop and trade future user goods, services, and/or skills at a specified future time, for financial help, loans, virtual cash virtual currency (VCVC), medical services, or any variation of help. A Virtual World try out product device attached to the human key device for users to be able to try out products, services, or ideas, in a user's own space, the virtual world, or in real world stores, or at point of purchase, or point of display, and additionally a method and device for a user to get virtual cash virtual currency (VCVC) for trying out things in the Virtual World or real world.

In another embodiment, Color Band Encryption De-Encryption can be used for identification and authentication. A user 801 speaks into electronic device 802 equipped with a microphone 803 and 3D cameras 804. The cameras 804 target the tip of the nose of the user 801. The human key server 805 performs 17 pattern matching and processor tests and routines and Creates pixel color band array converted to position numbers 808. The audio and video can also be captured by mobile devices 806 or an ATM machine 807. Wavelength data is created into encrypted numbers, stored in database and then de-encrypted for identification 809. Then final number is compared with “wavelength Fourier Wave Form”, “3D Analysis”, “Audio Fingerprint”, “Video Fingerprint” and a 100% match is obtained for identification 810. Flash produces tighter range 811. Shades of lightness or darkness always in the same live range 812.

In yet another embodiment of the present invention, an Artificial Neuron Processor device (GANPM), that is made up of a sensory device for responding to stimulus, of touch, sound, and light, temperature, contained in a liquid for the purpose of cooling, communication, noise reduction and chemical stimulations of the device. The device communicates information and data of reactions to stimulus directly to the Main processor, and/or the other Artificial Neuron Processor devices for decisions, in recognition of objects, spatial distances, positions, human faces, and human words. The device transformation of stimulus from Artificial Neuron Processor devices (GANPM) and/or Artificial Neuron Processor device Arrays (GANPMA), for visual and audio identification, by utilizing processes, where a plurality of Artificial Neuron Processor devices, each having their own stimulation reactions tasks preprogrammed, are used for the purpose of the device reacting to stimulus, independent of each other device, and furthermore are not affected by each other's separate programmed stimulus task, or response firing from stimulus, and furthermore in the event that the independent Artificial Neuron Processor device fires, after reacting to having been stimulated by some stimulus, the firing of the neuron, is instantly communicated to, and causes a reaction in the main processor, and furthermore where each Artificial Neuron Processor device can have a plurality of independent stimulus processes programmed into it, so it can multitask, and communicate with the main processor and other Artificial Neuron Processor devices(GANPM), but not be affected by other Artificial Neuron Processor device units. All devices can work in a Virtual World(s) and/or non virtual world(s), in digital computers, and/or Quantum computers, and/or Neuron Computers and/or online or offline. All devices can be attached to the human key, for identification, programming, and security. The Artificial Neuron Processor device (GANPM), can be used in the human key device system, as a 22nd redundancy check device for identification of a human, a plurality of humans, or an object or a plurality of objects, throughout the system and all the devices

In another embodiment of the present invention an incentive device for utilizing points, and discounts with scanning, capabilities for matching with products can be incorporated into the method. The first step is to scan to see if the product has a rebate, discount, coupon, or Virtual Cash incentive that can be used in the current purchase being considered. The device is connected to the human key for identification. A user has to simply scan the product with their mobile phone, hand held, or any device enabled with product registration scanning capabilities, to see the discount, other offers, Adopt Anything or Collaboration Group Buy Sell incentive campaigns. A user then purchases and gets the incentive, discount, coupon, or information. The purchase is then charged to the user's Human key, or a user is the card account.

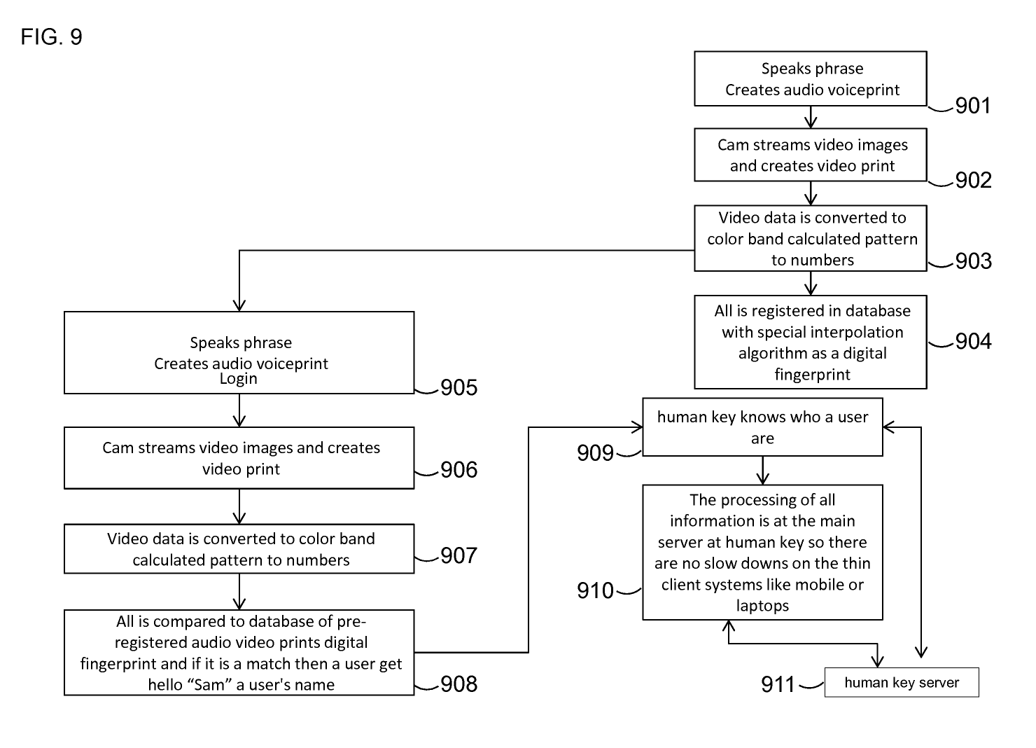

Now referring to FIG. 9, the method for the identification process of the present invention is shown. A user first speaks to create an audio voice print 901. Cam streams video images and creates video print 902. Video data is converted to color band calculated pattern to numbers 903. All is registered in database with special interpolation algorithm as a digital fingerprint 904. Next the user speaks a phrase and creates an audio voiceprint login 905. The cam streams video images and creates a video print 906. Video data is converted to color band calculated pattern to numbers 907. All is compared to database of pre- registered audio video prints digital fingerprint and if it is a match then a user get hello “Sam” your name 908. The human key knows who a user is 909 on the human key server 911. The processing of all information is at the main server at human key so there are no slowdowns on the thin client systems like mobile or laptops 910.

The human key can be attached to anything such as consignments, specific individuals in a corporation, object or devices for users in a virtual world, Virtual Purchases, Individual Steel Vaults, Virtual Vaults, or any vault, or bank account in a Virtual World, real world purchases, sales transactions, loans; layaway of products and/or services for spreading payments out over a period of time; credits or debits transactions, barters or trades transactions; spoken transactions; collaborative applications, with a project calendar; and anything can be attached to the human key by corporations, entities, governments, for profit or non-profit, schools, groups, individuals.

The present invention can also process data into intelligent data utilizing a reminder algorithm. Date is entered via text, audio, or video input and identified and authenticated by a human key server. The data can then be displayed, searched, sent to, or set as a reminder and displayed on a computer, or other electronic mobile device.

In yet another embodiment, a method and device for transforming ITAVMIST virtual free space projection display into a multi touch screen free space display device is taught by the present invention. The changes in intersecting infrared laser points aggregated by the ITAVMIST device, records, processes, transforms and creates the information needed for further tracking the touched areas in real time. With the processing and transformations in the servers, the touched areas can be utilized as a control device for the free space display utilizing the transformed pixel points affected by touching the free space pixel area and in applications designed for that purpose, such as scrolling through a gallery of images in free space by just touching the free space projection and sliding your finger along a path, to scroll to the next image.

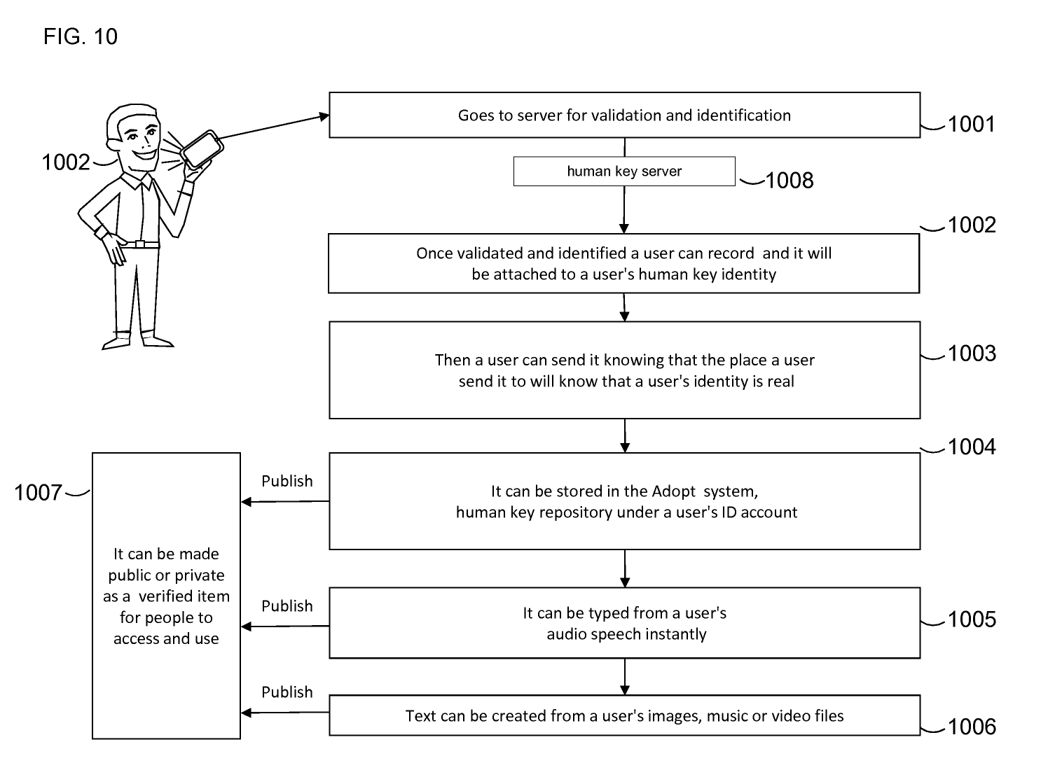

Now referring to FIG. 10, the method for speaking and publishing storage and distribution device with human key device is shown. In the first step, a user 1002 uses a computer or mobile electronic device to access the human key server 1008 for validation and identification 1001. Once validated and identified a user can record anything and it will be attached to your human key identity 1002. Then a user can send it knowing that the place a user send it to will know that your identity is real 1003. It can be stored in the system's human key repository under their ID account 1004. It can be typed from your audio speech instantly 1005. Text can be created from your images, music or video files 1006. It can be made public or private as a verified item for people to access and use 1007.

The human key server can places sponsor ads in search engines, press releases, campaigns videos, blogs, articles, websites, in print media, magazines, books, billboards, coupon books or mobile applications or emails. By using the human key for place the ads, a secure payment system, tracking and advertisement creation and placement system is created.

The method also teaches a rating system where a user, using the same audio and video authentication process, access the system where certified and authenticated ratings can be provided, stored, and utilized. In one embodiment, the rating system and provide a plurality of colored shields corresponding to the level of authentication and certification of a user as well as providing an indicator if they are open or close to accepting licensing of their property. The first color of the shield would identify if a user is registered and identified, a second color of the shield who signal that a user is registered, identified, and authenticated, while a third shield color would signal that a user was registered, identified, authenticated, and certified. A colored bar associated with the shield image would use a first color to signal a user is open to licensing and a second color to signal a user is closed to licensing.

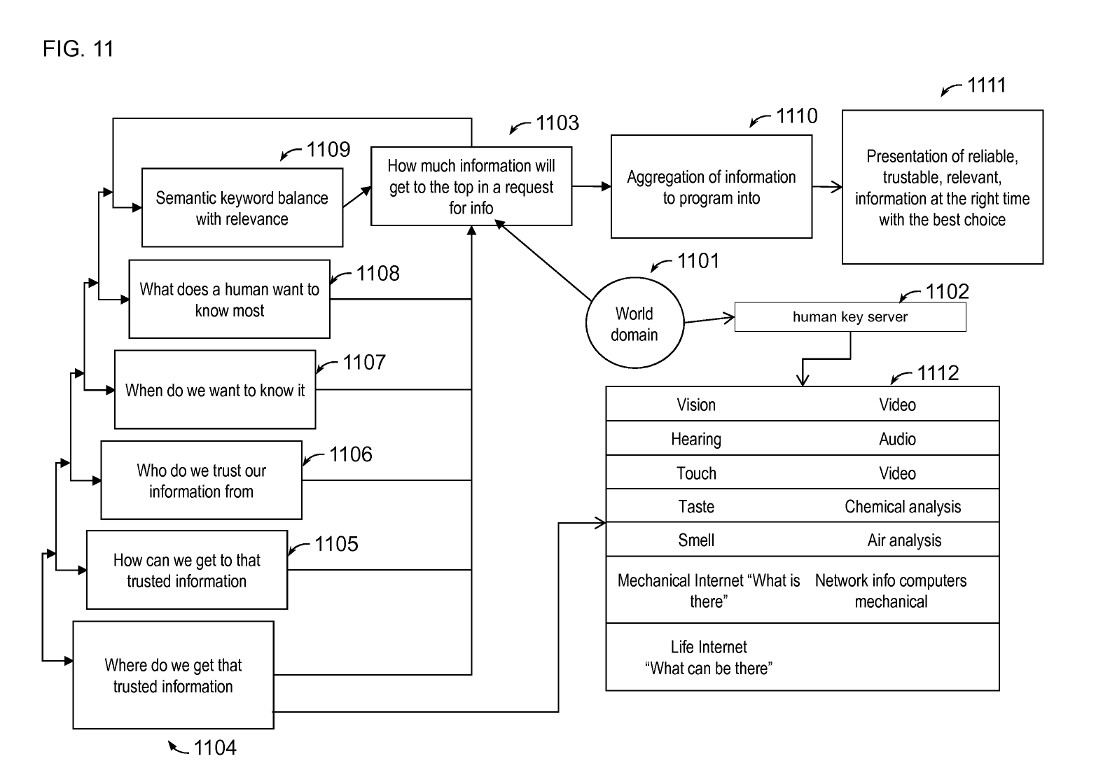

Now referring to FIG. 11, an indexing process is shown. A world domain 1101 is connected to a human key server 1102. In order to determine how much information will get to the top in a request for info 1103 a series of questions are asked: Where do we get that trusted information 1104 and access databases 1112; How can we get to that trusted information 1105; Who do we trust our information from 1106; When do we want to know it 1107; What does a human want to know most 1108; and Semantic keyword balance with relevance 1109. The indexing process then aggregated the information 1110 and the presence is reliable trustable, relevant, information at the right time with the best choice 1111.

In another embodiment a Virtual and Non Virtual World Franchises system attached to the human key list franchises to be bought or sold. A user can manage, track and transact royalties paid to original franchise business or store; create independent ownership contracts, and agreements; list and test potential franchise schemes and find interest in group ownership transactions; and manage all aspects of the creation, and running of franchises, including using virtual cash virtual currency (VCVC) for franchise fees, in the virtual world and non virtual world.

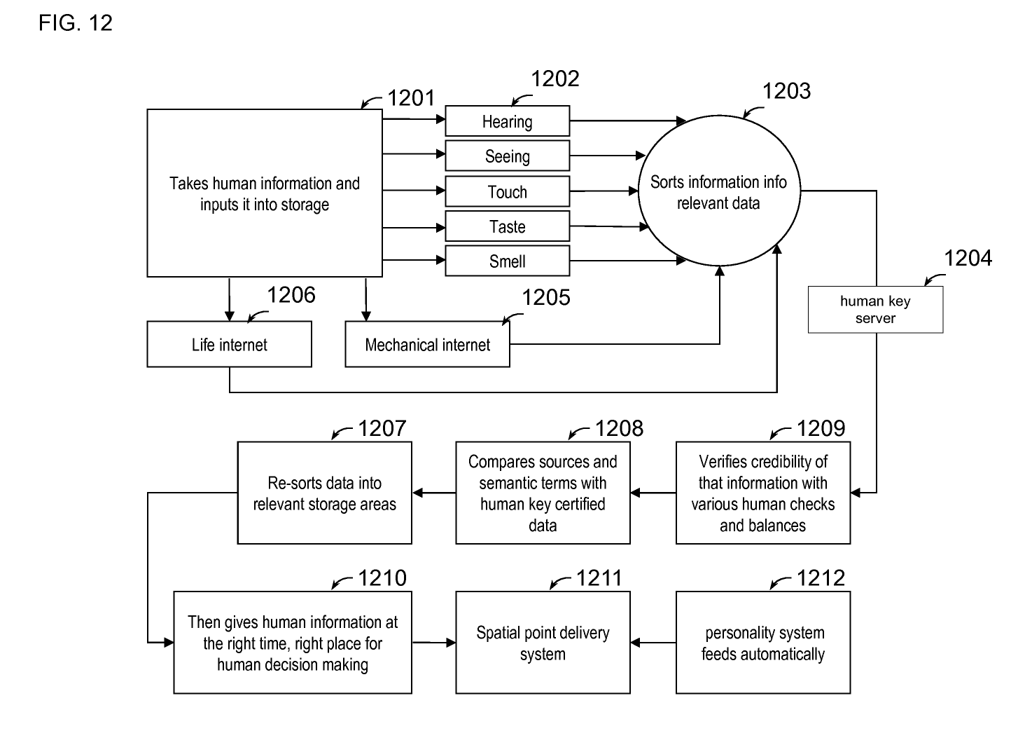

Now referring to FIG. 12 the human key is connected to a sense system which takes human information and inputs it into storage 1201 via a life internet 1206 and mechanical internet 1205. Sense input 1202 is stored in relevant databases 1203 connected to the human key 1204. The human key server 1204 Verifies credibility of that information with various human checks and balances 1209; Compares sources and semantic terms with human key certified data 1208; Re-sorts data into relevant storage areas 1207; Then gives human information at the right time, right place for human decision making 1210 Spatial point delivery system 1211; and feeds a personality system automatically 1212.

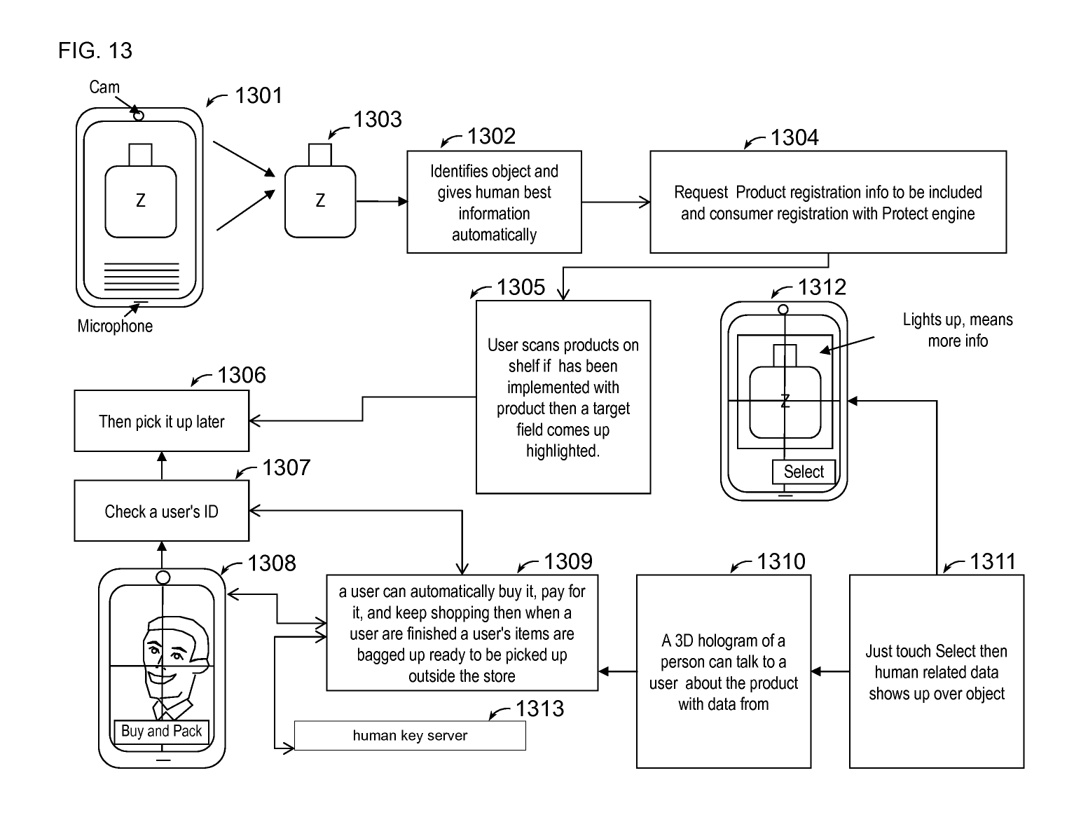

Now referring to FIG. 13, the human key product identification and registry method is disclosed. A user identifies an object 1303 with a smart phone device 1301 and gives human best information automatically 1302. Request Anything Product registration info to be included and consumer registration with Protect engine 1304. User scans products on shelf if has been implemented with product then a target field comes up highlighted 1305. Then pick it up later 1306. Check a user's ID 1307 using a smart phone 1308. A user can automatically buy it, pay for it, and keep shopping then when a user are finished a user's items are bagged up ready to be picked up outside the store 1309 using the human key server 1313. A 3D hologram of a person can talk to a user about the product with data from 1310. Just touch Select then human related data shows up over object 1311. Lights up, means more info 1312.

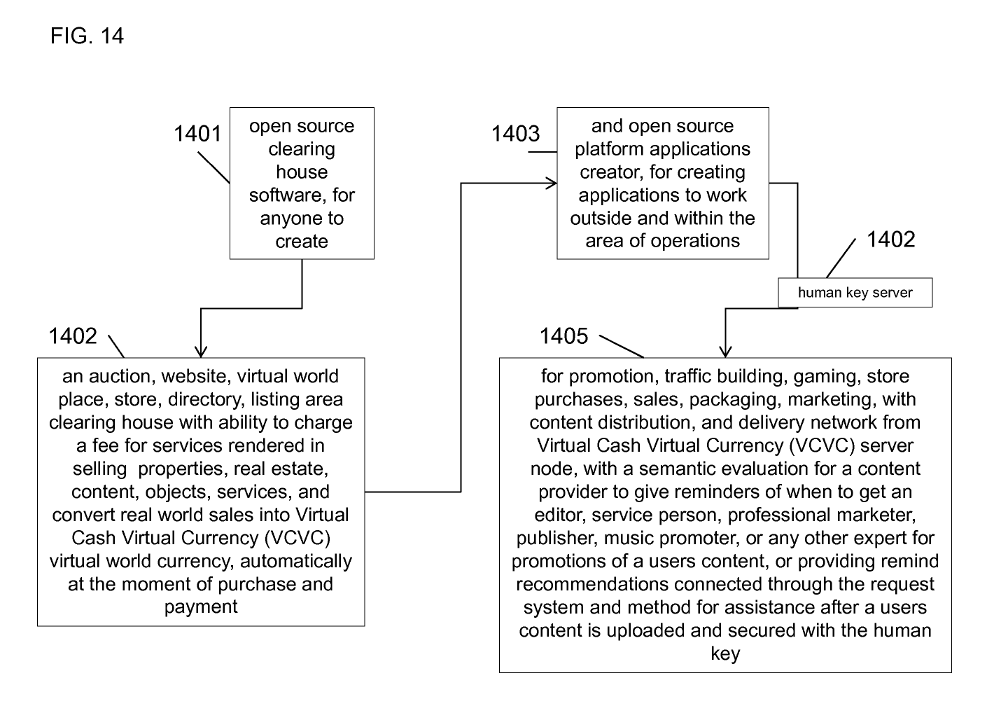

FIG. 14 illustrates an Open Source Clearing House Software device in Virtual and Non Virtual World. First open source clearing house software is provided 1401, for anyone to create an auction, website, virtual world place, store, directory, listing area clearing house with ability to charge a fee for services rendered in selling properties, real estate, content, objects, services, and convert real world sales into virtual cash virtual currency (VCVC) virtual world currency, automatically at the moment of purchase and payment 1402. AN open source platform applications creator is provided, for creating applications to work outside and within the area of operations 1403 and is connected to the human key server 1404 for promotion, traffic building, gaming, store purchases, sales, packaging, marketing, with content distribution, and delivery network from virtual cash virtual currency (VCVC) server node, with a semantic evaluation for a content provider to give reminders of when to get an editor, service person, professional marketer, publisher, music promoter, or any other expert for promotions of a user's content, or providing remind anything recommendations connected through the request anything system and device for assistance after a user's content is uploaded and secured with the human key 1405.

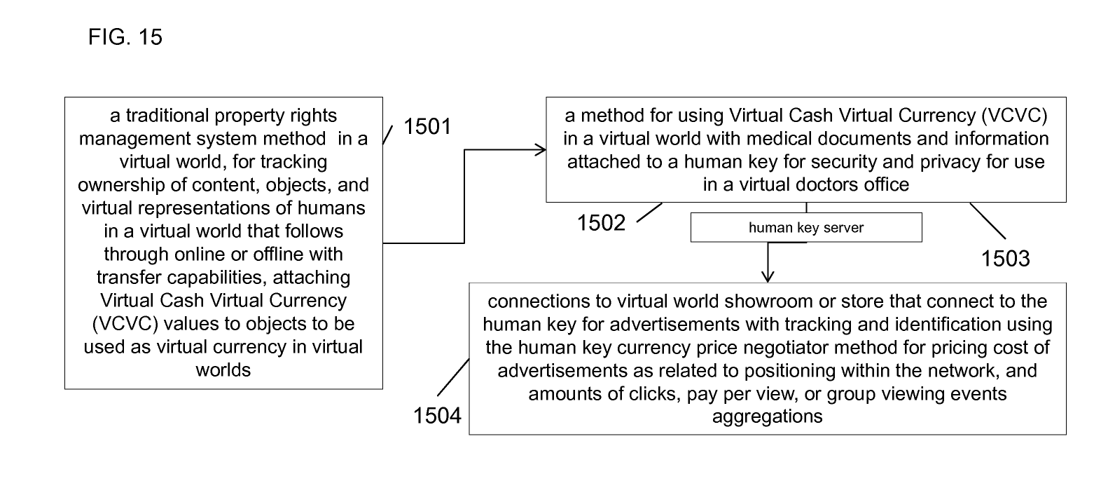

Now referring to FIG. 15, a method for the human key attached to property rights management is shown. A traditional property rights management system device in a virtual world, for tracking ownership of content, objects, and virtual representations of humans in a virtual world that follows through online or offline with transfer capabilities, attaching virtual cash virtual currency (VCVC) values to objects to be used as virtual currency in virtual worlds 1501. A device for using virtual cash virtual currency (VCVC) in a virtual world with medical documents and information attached to a human key for security and privacy for use in a virtual doctor's office 1502 is connected to the human key server 1503. Connections to virtual world showroom or store that connect to the human key for advertisements with tracking and identification using the human key currency price negotiator device for pricing cost of advertisements as related to positioning within the network, and amounts of clicks, pay per view, or group viewing events aggregations 1504.

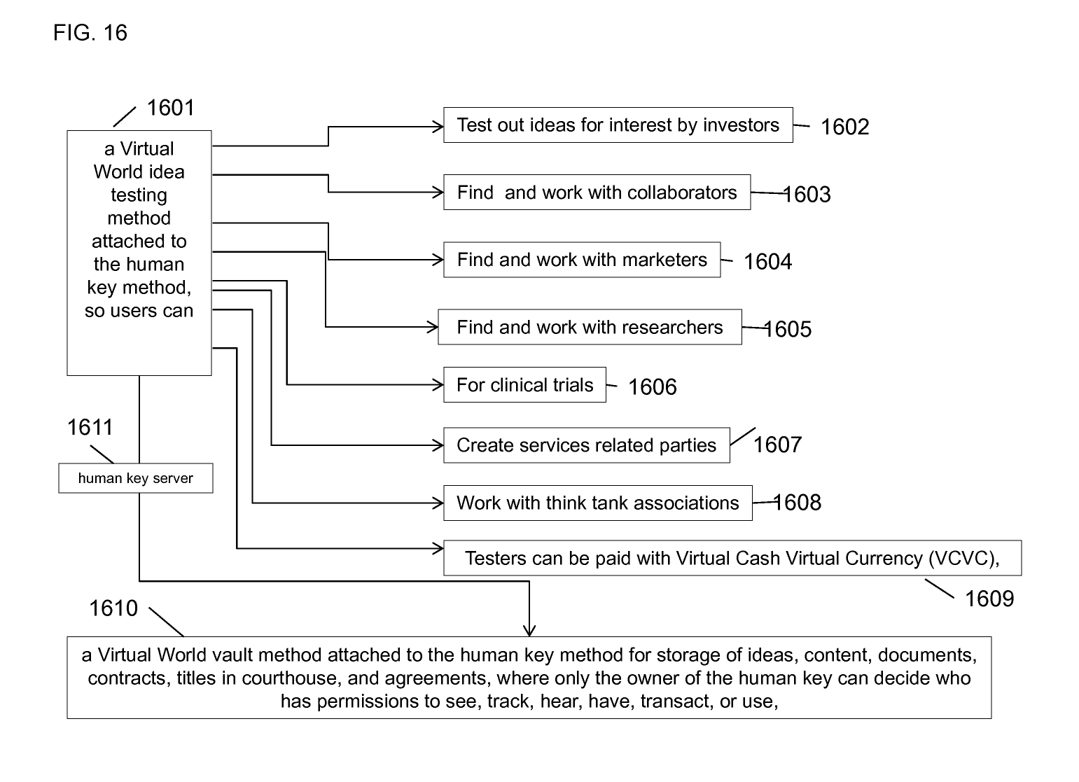

Now referring to FIG. 16, a Virtual World idea testing device attached to the human key method 1601, so users can: Test out ideas for interest by investors 1602; Find and work with collaborators 1603; find and work with marketers 1604; find and work with researchers 1605 for clinical trials 1606; create services related to parties 1607, work with think tank associations 1608; and Testers can be paid with virtual cash virtual currency (VCVC), 1609.

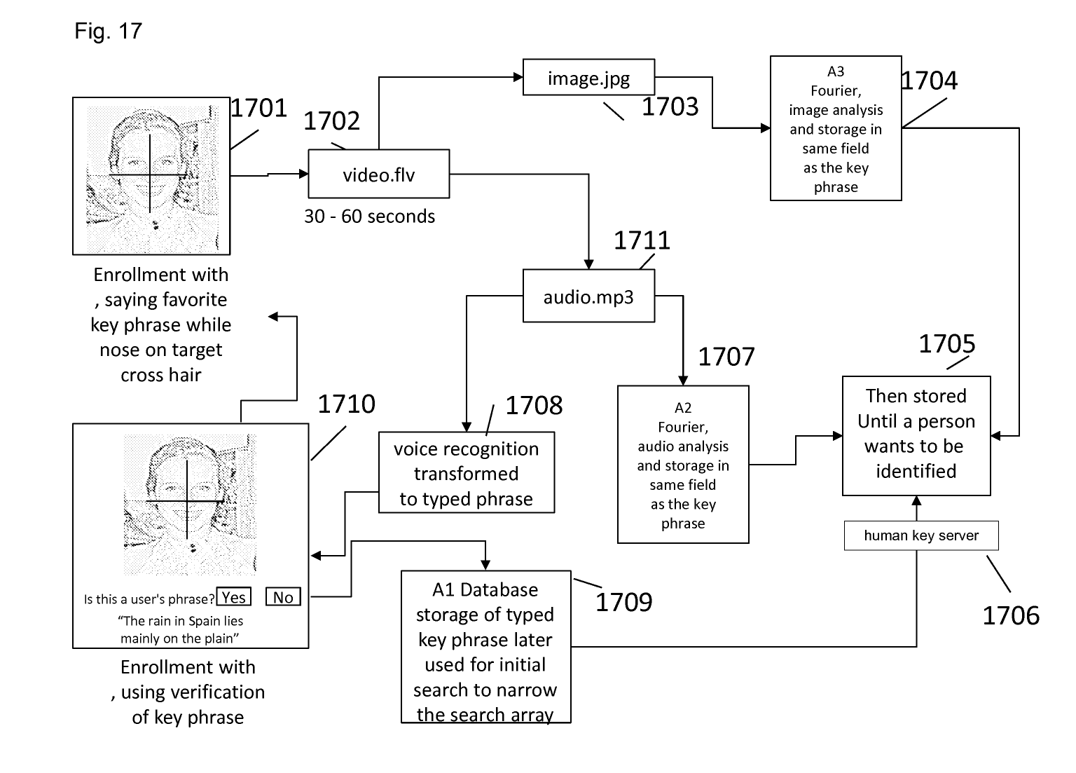

Now referring to FIG. 17, the phrase analysis and recognition method is shown. Enrollment begins with, saying favorite key phrase while nose on target cross hair 1701. A 30-60 second video is created 1702 and 300 images 1703 and audio 1711 are extracted for analysis. A Fourier, image analysis and storage in same field as the key phrase 1704 then stored until a person wants to be identified 1705 in the human key server 1706. A Fourier, audio analysis and storage in same field as the key phrase 1707. Voice recognition transforms the key phrase to a typed phrase 1708. A database storage of the typed key phrase later used for initial search to narrow the search array 1709. Enrollment can also be used by using verification of the key phrase 1710. Enrollment and Verification with other verification methods such as a driver's license, credit card data, Birth certificate, and social security number can also be performed.

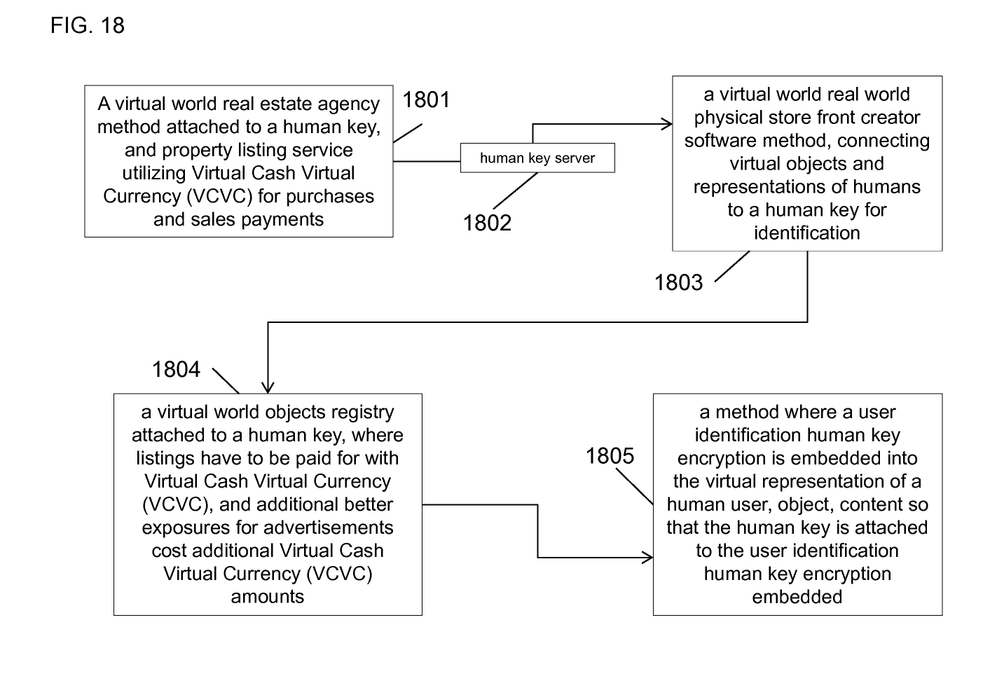

Now referring to FIG. 18, Virtual World Real Estate Agency, Objects registry, Store Front Creator methods are shown. A virtual world real estate agency method attached to a human key, and property listing service utilizing virtual cash virtual currency (VCVC) for purchases and sales payments 1801 is connected to a human key server 1802. A virtual world real world physical store front creator software method, connecting virtual objects and representations of humans to a human key for identification is provided 1803. A virtual world objects registry attached to a human key, where listings have to be paid for with virtual cash virtual currency (VCVC), and additional better exposures for advertisements cost additional virtual cash virtual currency (VCVC) amounts 1804. A method where a user identification human key encryption is embedded into the virtual representation of a human user, object, and content so that the human key is attached to the user identification human key encryption embedded 1805.

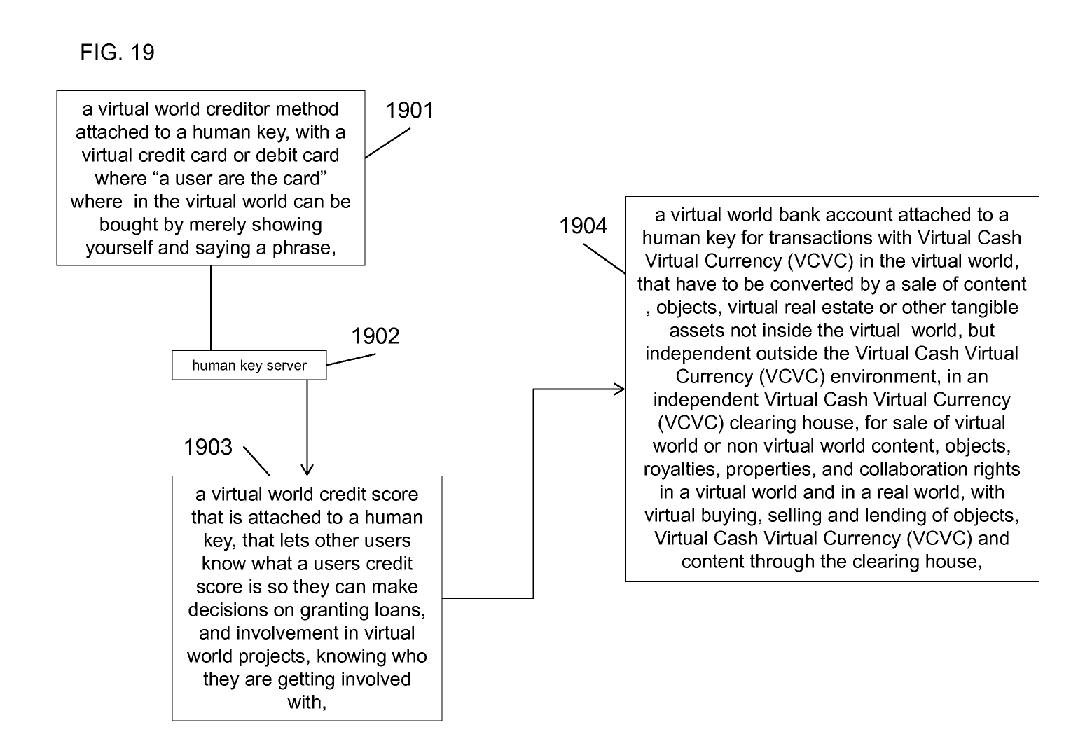

FIG. 19 illustrates a Virtual World Creditor, Credit Score, Bank Account methods. A virtual world creditor method attached to a human key, with a virtual credit card or debit card where “a user are the card” where anything in the virtual world can be bought by merely showing yourself and saying a phrase 1901 is attached to a human key server 1902. A virtual world credit score that is attached to a human key, that lets other users know what a user's credit score is so they can make decisions on granting loans, and involvement in virtual world projects, knowing who they are getting involved with 1903. A virtual world bank account attached to a human key for transactions with virtual cash virtual currency (VCVC) in the virtual world, that have to be converted by a sale of content, objects, virtual real estate or other tangible assets not inside the virtual world, but independent outside the virtual cash virtual currency (VCVC) environment, in an independent virtual cash virtual currency (VCVC) clearing house, for sale of virtual world or non virtual world content, objects, royalties, properties, and collaboration rights in a virtual world and in a real world, with virtual buying, selling and lending of objects, virtual cash virtual currency (VCVC) and content through the clearing house 1904.

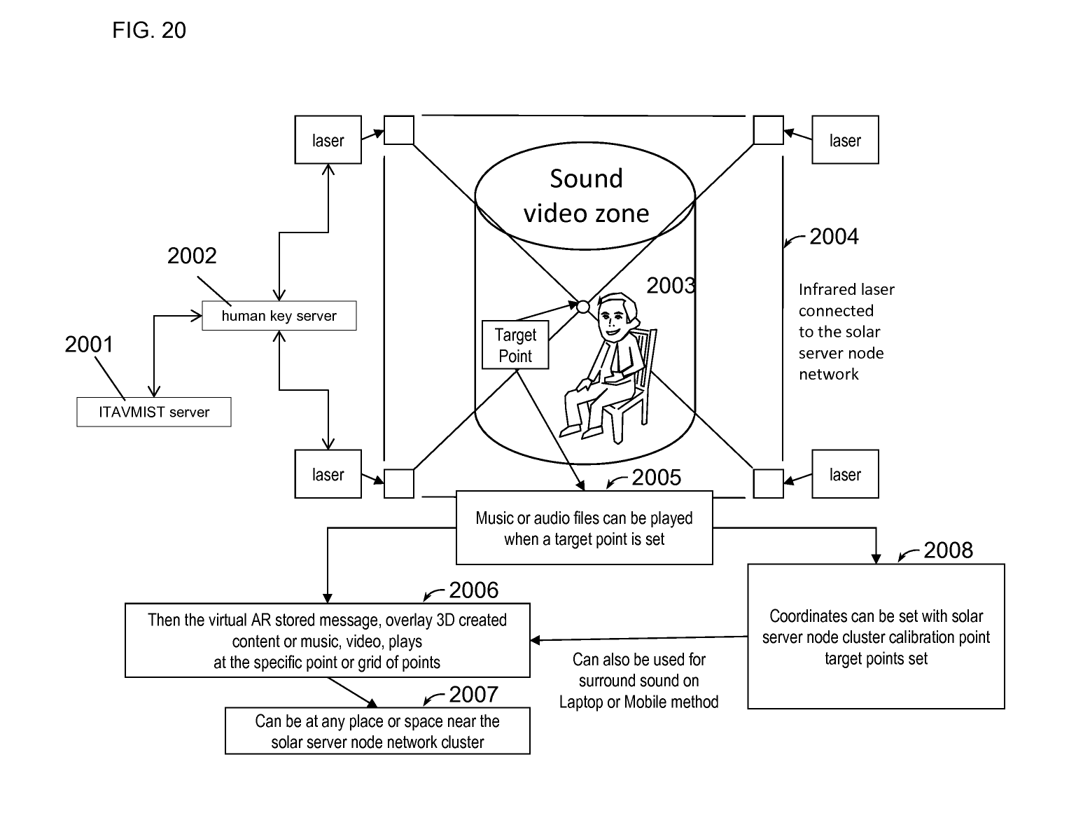

FIG. 20 illustrates Solar panel wind turbine communication server appliance node network infrared laser light waves transformed to audio sound waves with ITAVMIST 2001 and Human key 2002 at spatial point target zone 2003. Infrared or conventional laser Beamed from multiple sources 2004 to intersect at a point to create a sound at that spatial point target, with variations in intensity, and angle any audio can be transmitted to the target point Music or audio files can be played when a target point is set 2005. Then the virtual AR stored message, overlay 3D created content or music, video, plays at the specific point or grid of points 2006. Can be at any place or space near the solar server node network cluster 2007. Coordinates can be set with solar server node cluster calibration point target points set 2009.

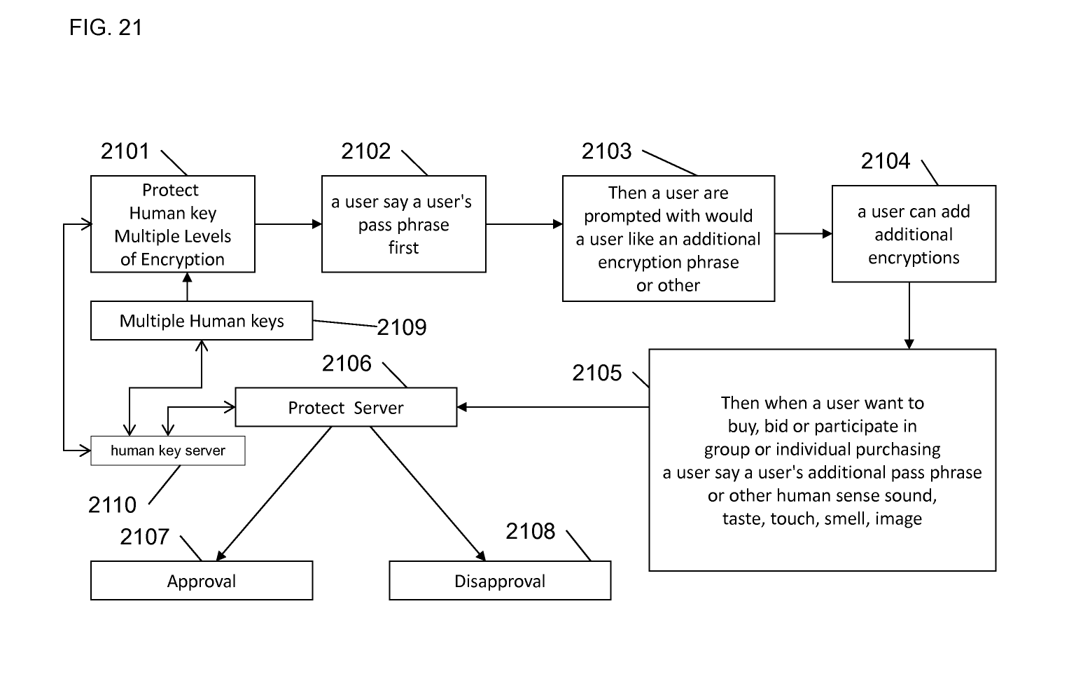

Now referring to FIG. 21, a human key additional multiple encryption audio single words, numbers, music, tones, phrases, human gestures, smells, tastes, symbols, authentication method is shown. Protect Anything Human key Multiple Levels of Encryption 2101. A user says a user's pass phrase first 2002. Then a user is prompted with would a user like an additional encryption phrase 2003 or a user can add additional encryptions 2004. Then when a user want to buy, bid or participate in group or individual purchasing a user say a user's additional pass phrase or other human sense sound, taste, touch, smell, image 2005. The protection server 2006 either approves 2007 or disapproves 2008 after receiving input from multiple human keys 2009 and the human key server 2010.

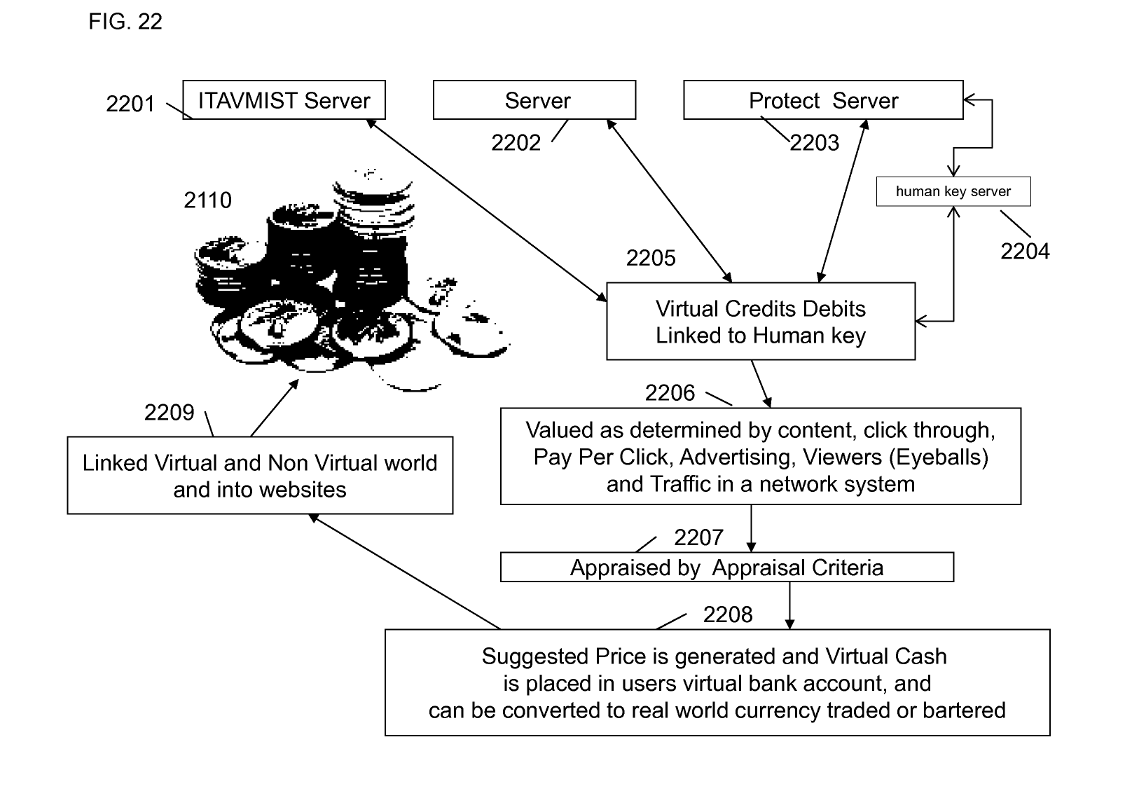

Now referring to FIG. 22, Illumination Transformer Audio Video Manager Interactive Server Transmitter (ITAVMIST) virtual credits and debits method is shown. First an ITAVIMIST Server 2201, server 2202, protect server 2203 and human key server 2204 track Virtual Credits Debits Linked to Human key 2205. Value is as determined by content, click through, Pay Per Click, Advertising, Viewers (Eyeballs) and Traffic in a network system 2206. The value is appraised by appraisal criteria 2207. Suggested Price is generated and Virtual Cash is placed in user's virtual bank account, and can be converted to real world currency traded or bartered 2208. Linked Virtual and Non Virtual world and into websites 2209 and converted to real cash 2210.

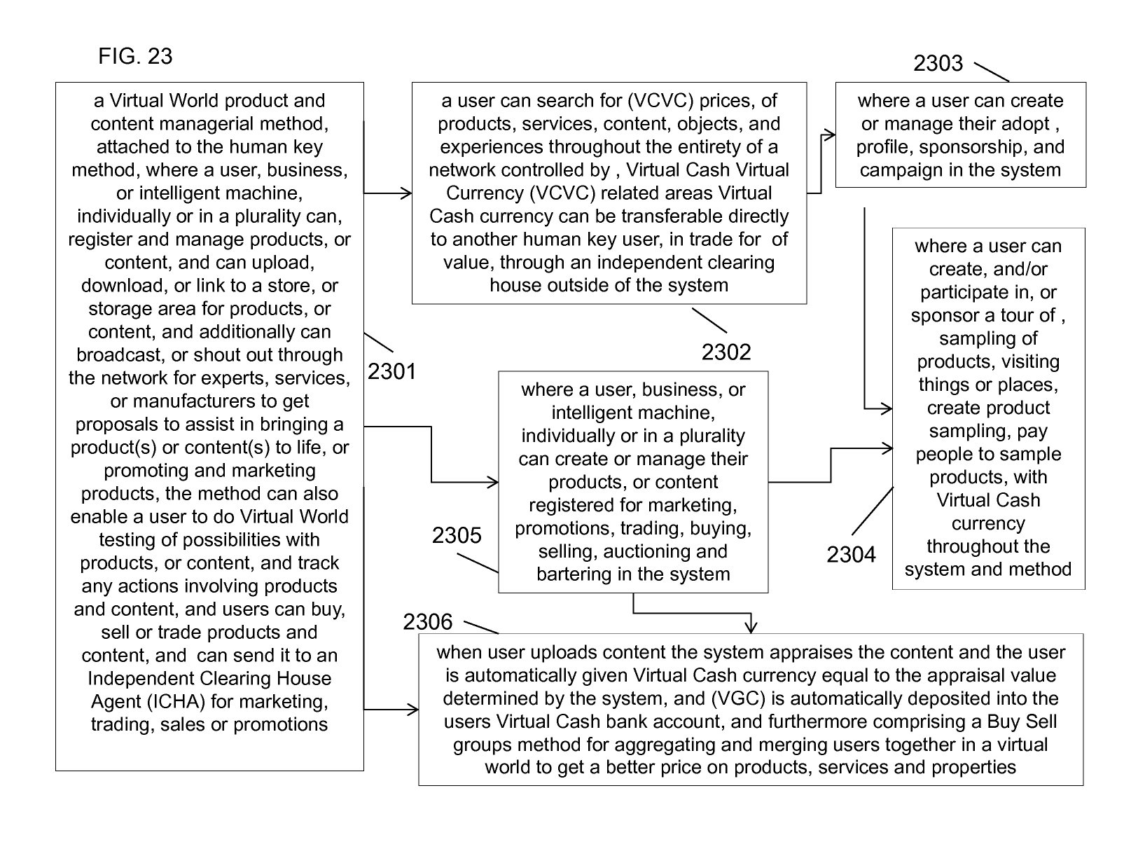

FIG. 23 illustrates the Virtual and Non Virtual World Product, Content Registry method taught by the present invention. A Virtual World product and content managerial method, attached to the human key method, where a user, business, or intelligent machine, individually or in a plurality can, register and manage products, or content, and can upload, download, or link to a store, or storage area for products, or content, and additionally can broadcast, or shout out through the network for experts, services, or manufacturers to get proposals to assist in bringing a product(s) or content(s) to life, or promoting and marketing products, the method can also enable a user to do Virtual World testing of possibilities with products, or content, and track any actions involving products and content, and users can buy, sell or trade products and content, and can send it to an Independent Clearing House Agent (ICHA) for marketing, trading, sales or promotions 2301. A user can search for (VCVC) prices, of products, services, content, objects, and experiences throughout the entirety of a network controlled by, virtual cash virtual currency (VCVC) related areas Virtual Cash currency can be transferable directly to another human key user, in trade for anything of value, through an independent clearing house outside of the system 2302 where a user can create or manage their adopt anything, profile, sponsorship, and campaign in the system 2303. A user can create, and/or participate in, or sponsor a tour of anything, sampling of products, visiting things or places, create product sampling, pay people to sample products, with Virtual Cash currency throughout the system and method 2304. A user, business, or intelligent machine, individually or in a plurality can create or manage their products, or content registered for marketing, promotions, trading, buying, selling, auctioning and bartering in the system 2305. When user uploads content the system appraises the content and the user is automatically given Virtual Cash currency equal to the appraisal value determined by the system, and (VGC) is automatically deposited into the users Virtual Cash bank account, and furthermore comprising a Buy Sell Anything groups method for aggregating and merging users together in a virtual world to get a better price on products, services and properties 2306.

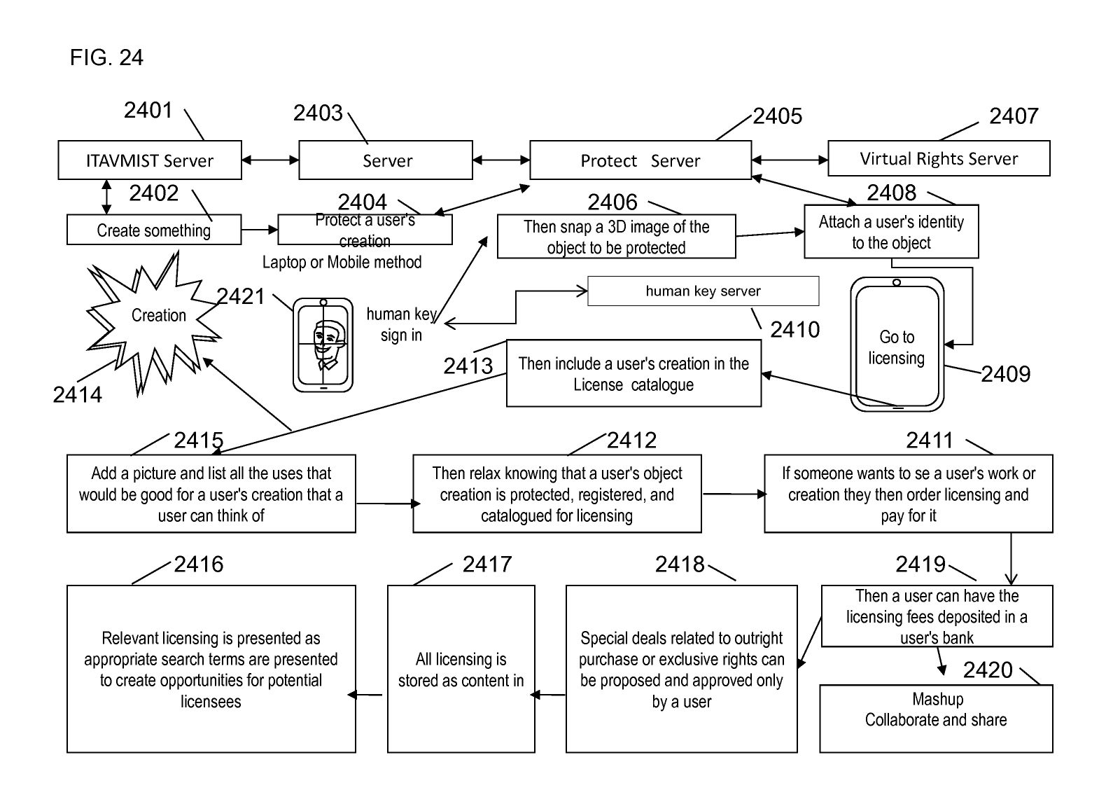

FIG. 24 illustrates an Illumination Transformer Audio Video Manager Interactive Server Transmitter (ITAVMIST) creations, licensing and attaching human key to intellectual property method. An ITAVMIST server 2401 is used to create something 2402 in combination with a server 2403 and a protect the user's creation 2404 using the protect server 2405 and a virtual rights server 2407. A user signs in 2421 the a 3D image of the object to be protected is snapped 2406 and attached to a user's identity 2408 using the human key server 2410. The user then goes to licensing 2409. Then include a user's creation in the License Anything catalogue 2413. Add a picture and list all the uses that would be good for a user's creation that a user can think of 2415. Then relax knowing that a user's object creation is protected, registered, and catalogued for licensing 2412. If someone wants to see a user's work or creation they then order licensing and pay for it 2411 Then a user can have the licensing fees deposited in a user's bank 2419 to collaborate and or share 2420. Special deals related to outright purchase or exclusive rights can be proposed and approved only by a user 2418. All licensing is stored as content 2417. Relevant licensing is presented as appropriate search terms are presented to create opportunities for potential licensees 2416.

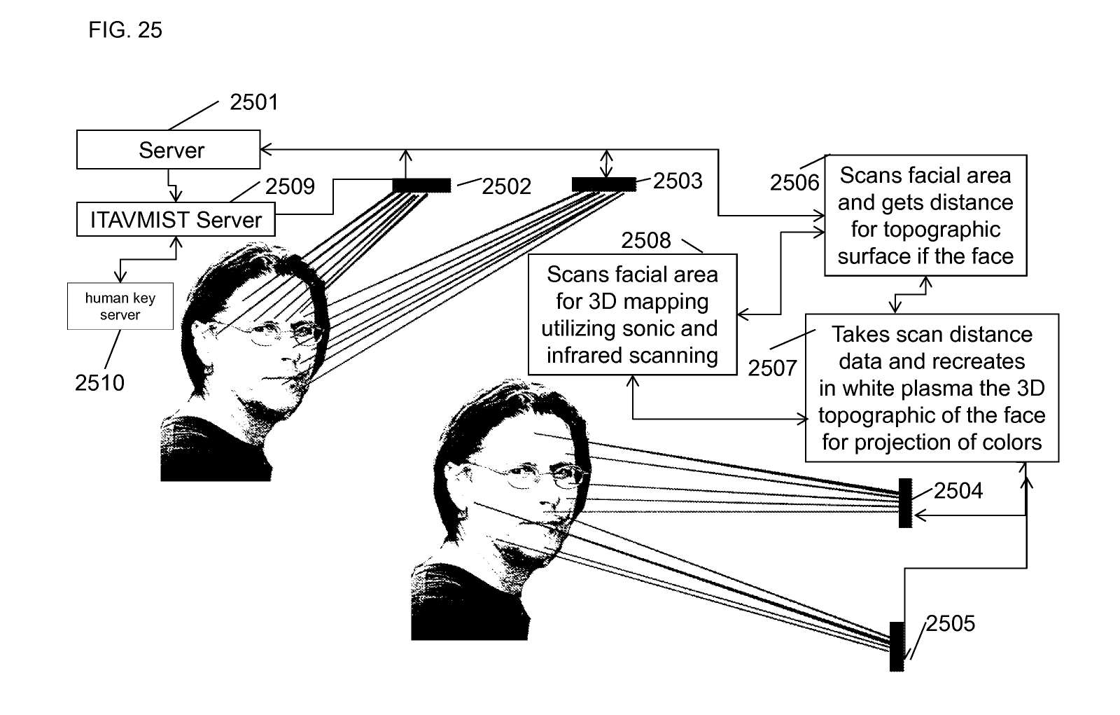

Now referring to FIG. 25, the Illumination Transformer Audio Video Manager Interactive Server Transmitter (ITAVMIST) infrared topographical pixel distance determination facial object, human key method is shown. A server 2501, ITAVMIST server 2509, and human key server 2510 uses cameras 2502, 2503, 2504, and 2505 to scan facial area and gets distance for topographic surface if the face 2506. Scans facial area for 3D mapping utilizing sonic and infrared scanning 2507. Takes scan distance data and recreates in white plasma the 3D topographic of the face for projection of colors 2508.

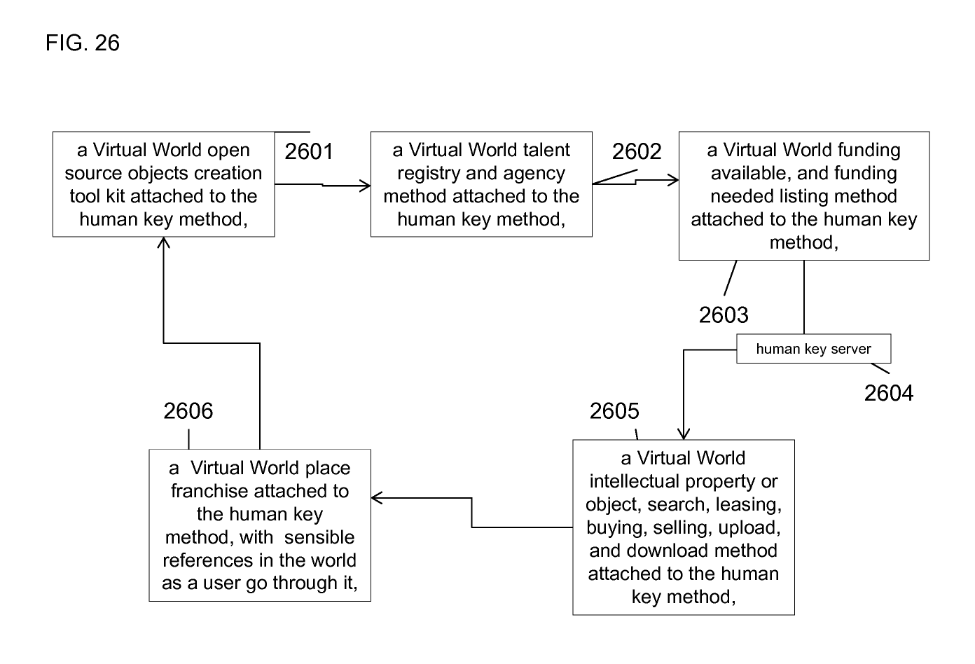

FIG. 26 illustrates a Virtual and Non Virtual World Talent Registry, Funding, Applications Management method. A Virtual World open source objects creation tool kit attached to the human key method 2601. A Virtual World talent registry and agency method attached to the human key method 2602. A Virtual World funding available, and funding needed listing method attached to the human key method 2603 connected to the human key server 2604. A Virtual World intellectual property or object, search, leasing, buying, selling, upload, and download method attached to the human key method 2605. A Virtual World place franchise attached to the human key method, with sensible references in the world as a user go through it 2606.

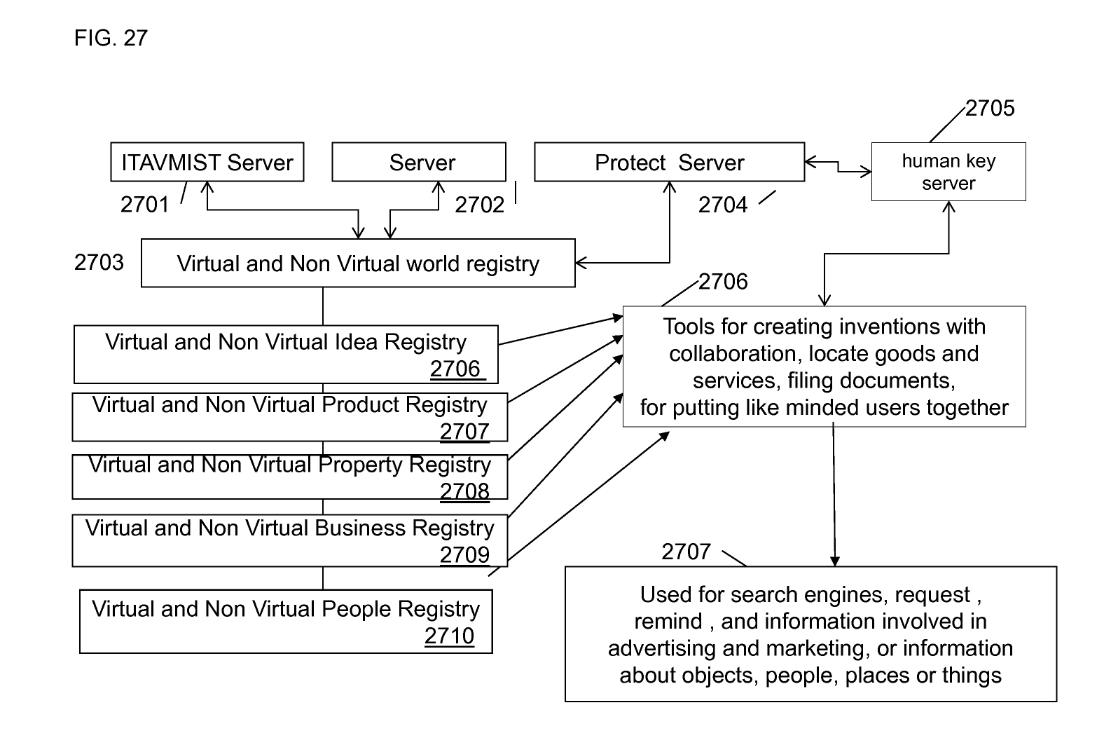

Now referring to FIG. 27 an Illumination Transformer Audio Video Manager Interactive Server Transmitter (ITAVMIST), human key Virtual and Non Virtual World Registry method is shown. The ITAVMIST server 2701 and server 2701 are connected to a Virtual and Non Virtual world registry 2703 with communicates with protect server 2704 and human key server 2705 providing Tools for creating inventions with collaboration, locate goods and services, filing documents, for putting like-minded users together 2706 for search engines, request, remind, and information involved in advertising and marketing, or information about objects, people, places or things 2707. The Virtual and Non Virtual world registry 2703 is comprised of: Virtual and Non Virtual Idea Registry 2706; Virtual and Non Virtual Product Registry 2707; Virtual and Non Virtual Property Registry 2708; Virtual and Non Virtual Business Registry 2709; Virtual and Non Virtual People Registry 2710.

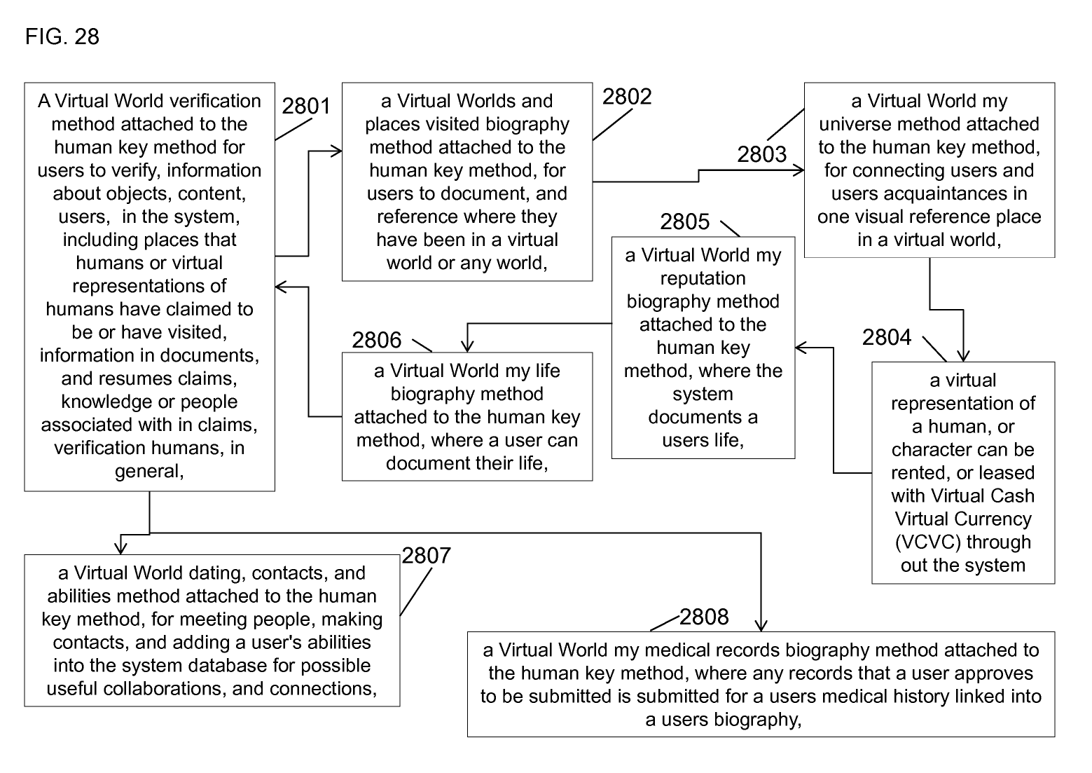

Now referring to FIG. 28 a Virtual World Biography, Reputation, Medical, Dating and Verification method is shown. A Virtual World verification method attached to the human key method for users to verify, information about objects, content, users, in the system, including places that humans or virtual representations of humans have claimed to be or have visited, information in documents, and resumes claims, knowledge or people associated with in claims, verification humans, in general 2801. A Virtual Worlds and places visited biography method attached to the human key method, for users to document, and reference where they have been in a virtual world or any world 2802. A Virtual World my universe method attached to the human key method, for connecting users and users acquaintances in one visual reference place in a virtual world 2803. A virtual representation of a human or character can be rented, or leased with virtual cash virtual currency (VCVC) throughout the system 2804. A Virtual World my reputation biography method attached to the human key method, where the system documents a user's life 2805. A Virtual World my life biography method attached to the human key method, where a user can document their life 2806. A Virtual World dating, contacts, and abilities method attached to the human key method, for meeting people, making contacts, and adding a user's abilities into the system database for possible useful collaborations, and connections 2807. A Virtual World my medical records biography method attached to the human key method, where any records that a user approves to be submitted is submitted for a user's medical history linked into a user's biography.

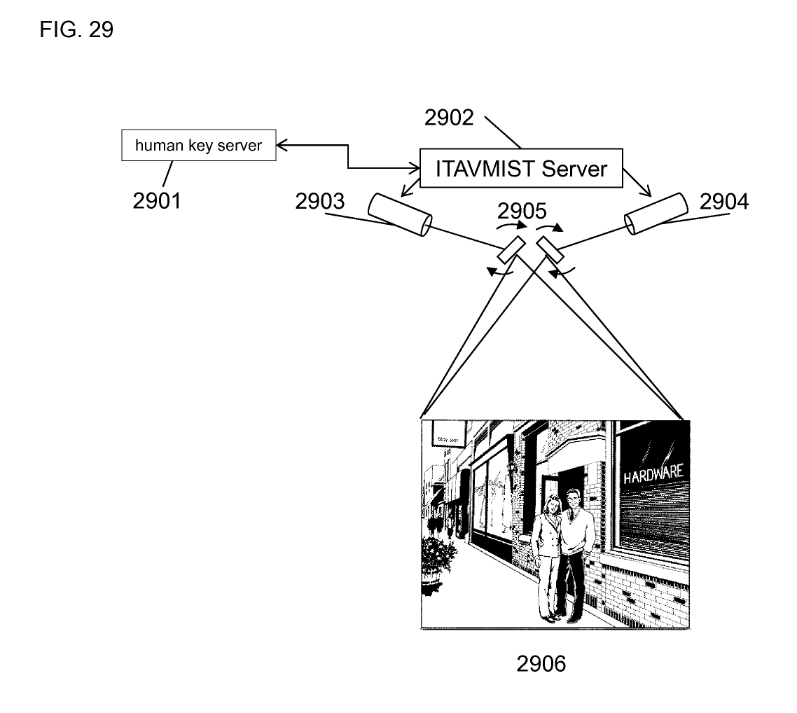

Now referring to FIG. 29 an Illumination Transformer Audio Video Manager Interactive Server Transmitter (ITAVMIST) Video Laser Scan Free Space Projection Targeted to Spatial Point Targets method is shown. A human key server 2901 and ITAVMIST server 2902 user lasers 2903 and 2904 and group of mirrors 2905 to create Free Space scan fine lines created by rotating the mirrors 2905 in front of laser spatial point target 2906. Free Space 2D or 3D Video created from infrared lasers, and visible light lasers in dimensional space utilizing scan lines for precise scanning a spatial point target 2906.

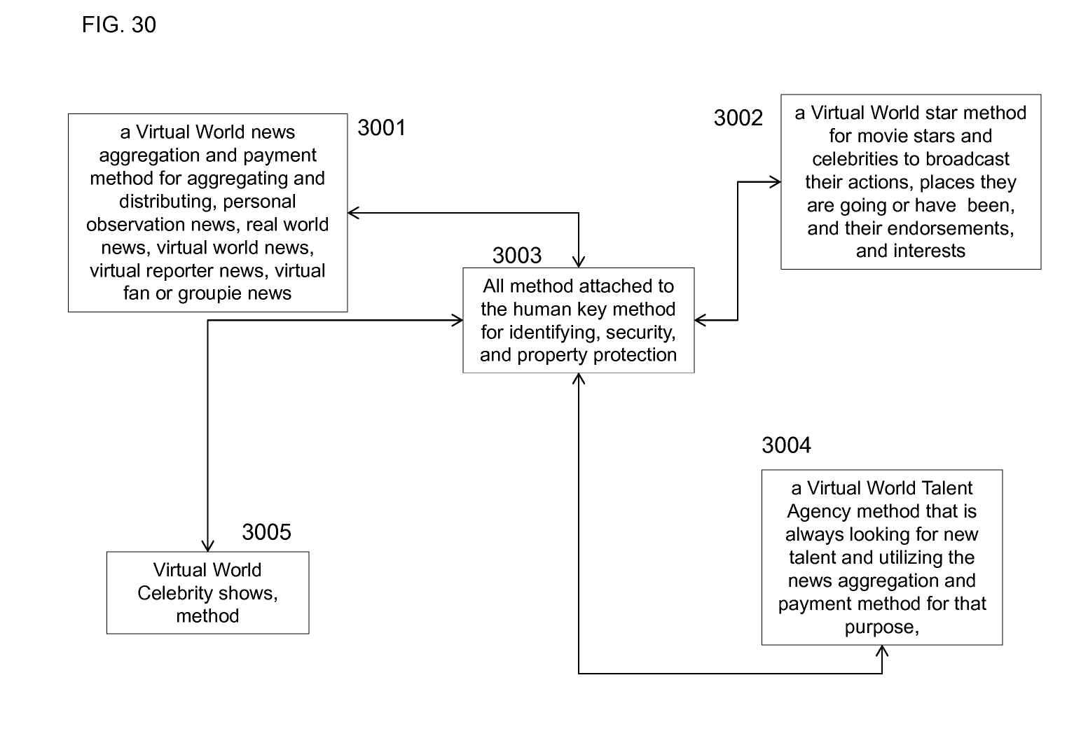

FIG. 30 shows a human key attached to News, Movie stars, Celebrities, and Talent Agency method. A Virtual World news aggregation and payment method for aggregating and distributing, personal observation news, real world news, virtual world news, virtual reporter news, virtual fan or groupie news 3001. A Virtual World star method for movie stars and celebrities to broadcast their actions, places they are going or have been, and their endorsements, and interests 3002. All method attached to the human key method for identifying, security, and property protection 3003. A Virtual World Talent Agency method that is always looking for new talent and utilizing the news aggregation and payment method for that purpose 3004. Virtual World Celebrity shows, method 3005.

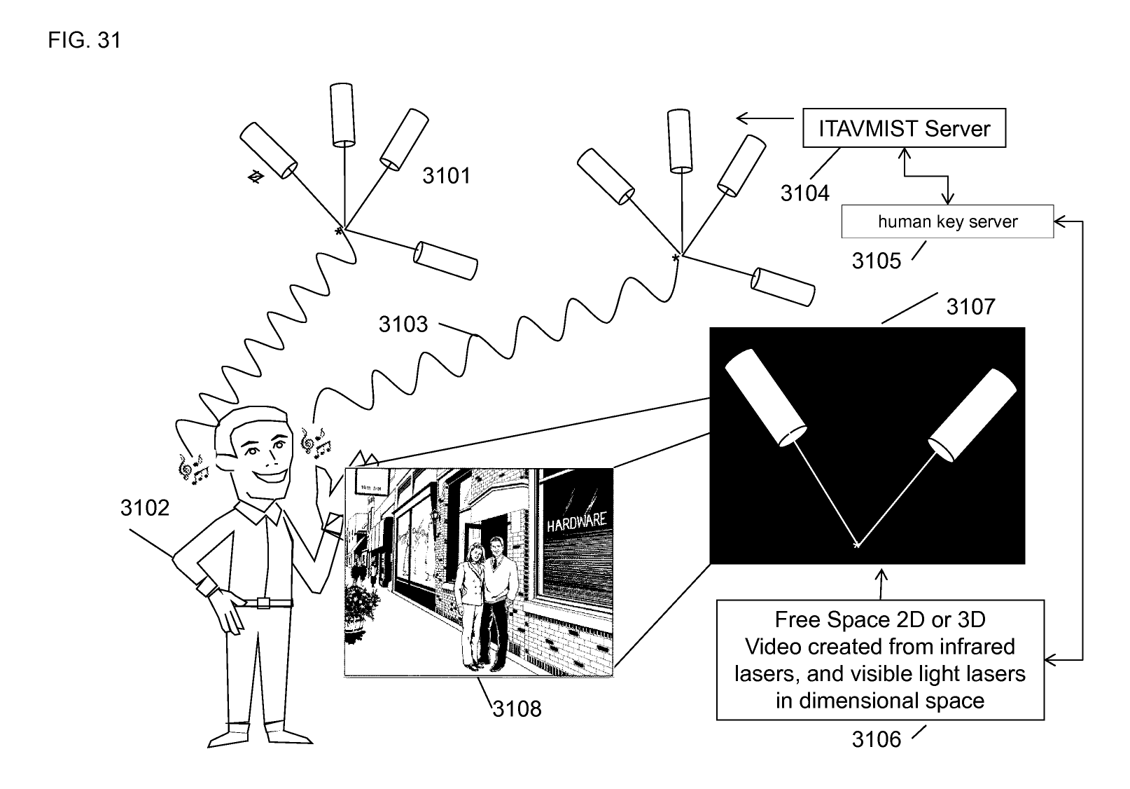

FIG. 31 shows an Illumination Transformer Audio Video Manager Interactive Server Transmitter (ITAVMIST) Audio Video Free Space Projection Targeted to Spatial Point Targets method. Free Space Stereo Audio created from infrared laser light 3101 converted to audio waves 3103 at spatial point target 3102 and captured by the ITAVMIST server 3104 and human key server 3105. Free Space 2D or 3D Video is created from infrared lasers, and visible light lasers 3107 in dimensional space 3108.

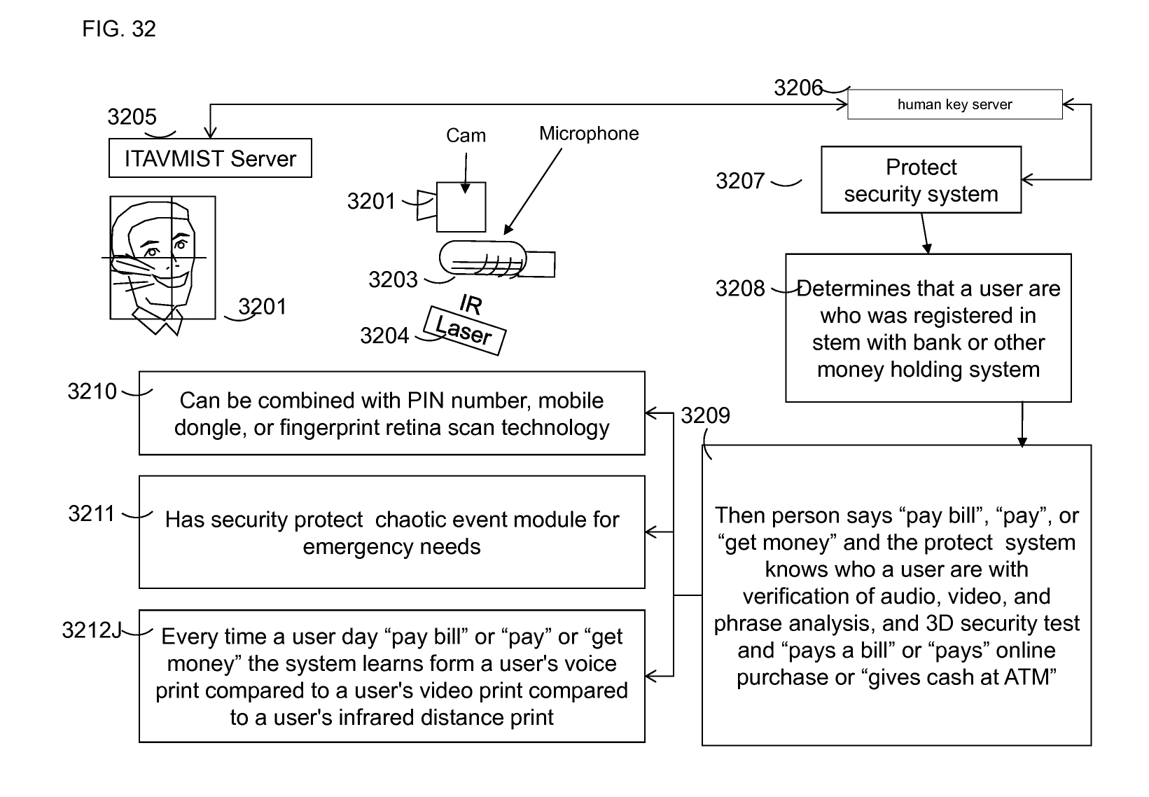

Now referring to FIG. 32 an Illumination Transformer Audio Video Manager Interactive Server Transmitter (ITAVMIST) Audio Video Credit Card System “a user is the Card” with “Human key” method is shown. A person 3201 speaks in front of cam 3202 with microphone 3203 and laser 3204. Infrared laser system measures distances on face and sends it to the ITAVMIST server 3205. The human key server 3206 and protect server 3207 determine that a user are who was registered in stem with bank or other money holding system 3208. Then person says “pay bill”, “pay”, or “get money” and the protect system knows who a user are with verification of audio, video, and phrase analysis, and 3D security test and “pays a bill” or “pays” online purchase or “gives cash at ATM” 3209. Can be combined with PIN number, mobile dongle, or fingerprint retina scan technology 3210. Has security protect chaotic event module for emergency needs 3211. Every time a user day “pay bill” or “pay” or “get money” the system learns form a user's voice print compared to a user's video print compared to a user's infrared distance print 3212.

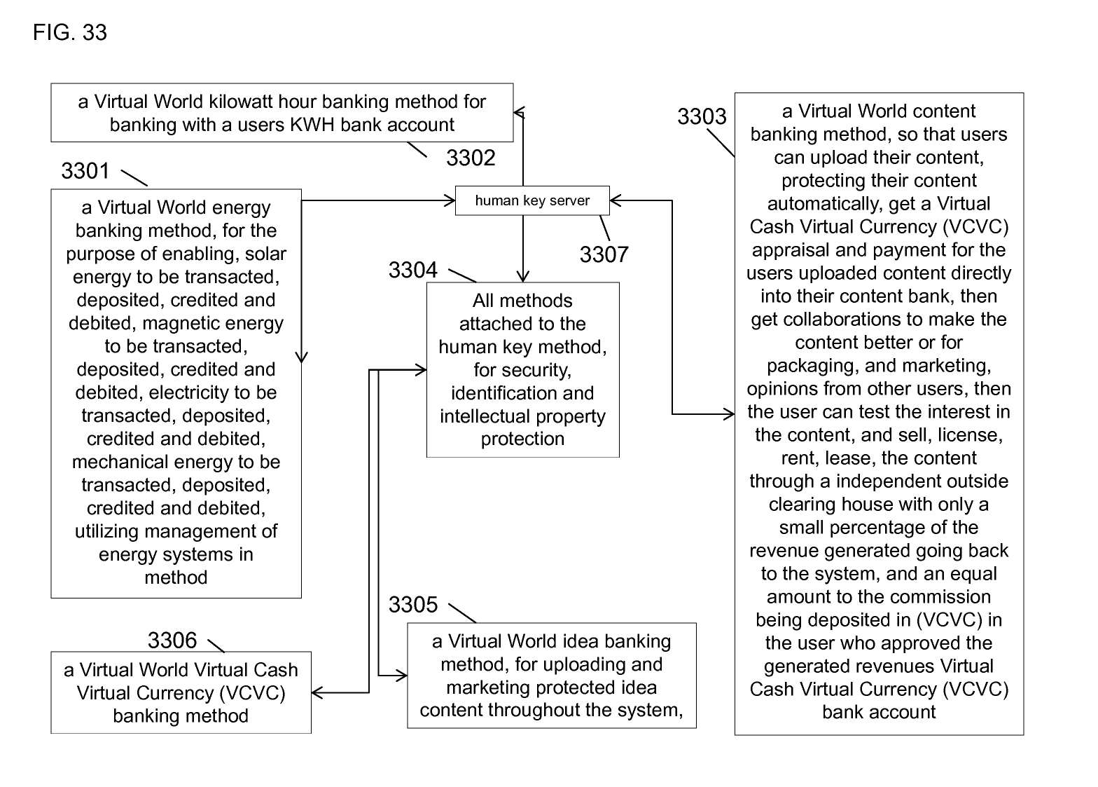

Now referring to FIG. 33, a Virtual World, Virtual Cash, KWH Bank, Energy bank, Idea Bank, Content bank method is shown. A Virtual World energy banking method, for the purpose of enabling, solar energy to be transacted, deposited, credited and debited, magnetic energy to be transacted, deposited, credited and debited, electricity to be transacted, deposited, credited and debited, mechanical energy to be transacted, deposited, credited and debited, utilizing management of energy systems in method 3301. A Virtual World kilowatt hour banking method for banking with a user's KWH bank account 3302. A Virtual World content banking method, so that users can upload their content, protecting their content automatically, get a virtual cash virtual currency (VCVC) appraisal and payment for the users uploaded content directly into their content bank, then get collaborations to make the content better or for packaging, and marketing, opinions from other users, then the user can test the interest in the content, and sell, license, rent, lease, the content through an independent outside clearing house with only a small percentage of the revenue generated going back to the system, and an equal amount to the commission being deposited in (VCVC) in the user who approved the generated revenues virtual cash virtual currency (VCVC) bank account 3303. All methods attached to the human key server 3307, for security, identification and intellectual property protection 3304. A Virtual World idea banking method, for uploading and marketing protected idea content throughout the system 3305. A Virtual World virtual cash virtual currency (VCVC) banking method 3306.

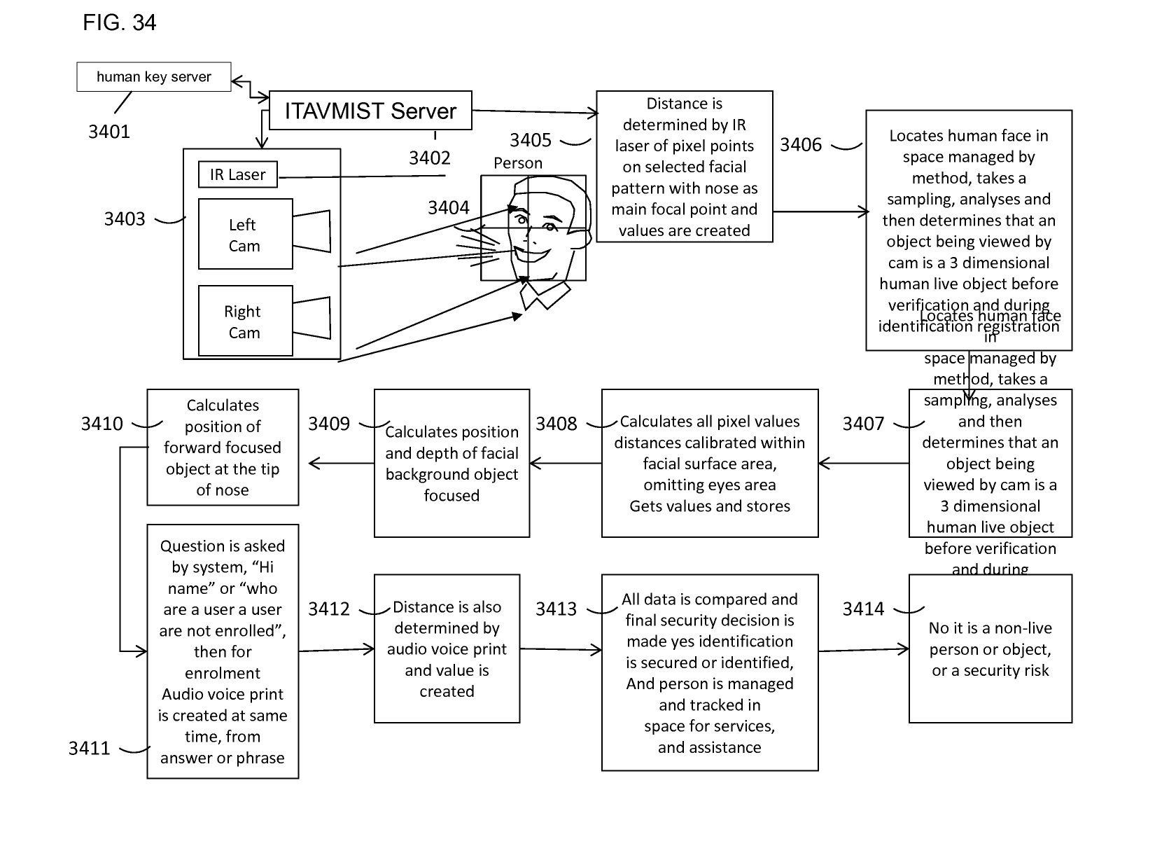

Now referring to FIG. 34, an Illumination Transformer Audio Video Manager Interactive Server Transmitter (ITAVMIST) Stereo 3D infrared pixel point facial distance, audio voice print identification method is shown. A human key server 3401 and ITAVMIST server 3402 are connected to a recording device 3403 comprised of an IR Laser, and left and right cameras for recording a person 3404. Distance is determined by IR laser of pixel points on selected facial pattern with nose as main focal point and values are created 3405. Locates human face in space managed by method, takes sampling, analyses and then determines that an object being viewed by cam is a 3 dimensional human live object before verification and during identification registration 3406. Locates human face in space managed by method, takes sampling, analyses, and then determines that an object being viewed by cam is a 3 dimensional human live object before verification and during identification registration 3407. Calculates all pixel values distances calibrated within facial surface area, omitting eyes area and Gets values and stores 3408. Calculates position and depth of facial background object focused 3409. Calculates position of forward focused object at the tip of nose 3410. Question is asked by system, “Hi name” or “who are a user a user are not enrolled”, then for enrolment Audio voice print is created at same time, from answer or phrase 3411. Distance is also determined by audio voice print and value is created 3412. All data is compared and final security decision is made yes identification is secured or identified, and person is managed and tracked in space for services, and assistance 3413. No it is a non-live person or object, or a security risk 3414.

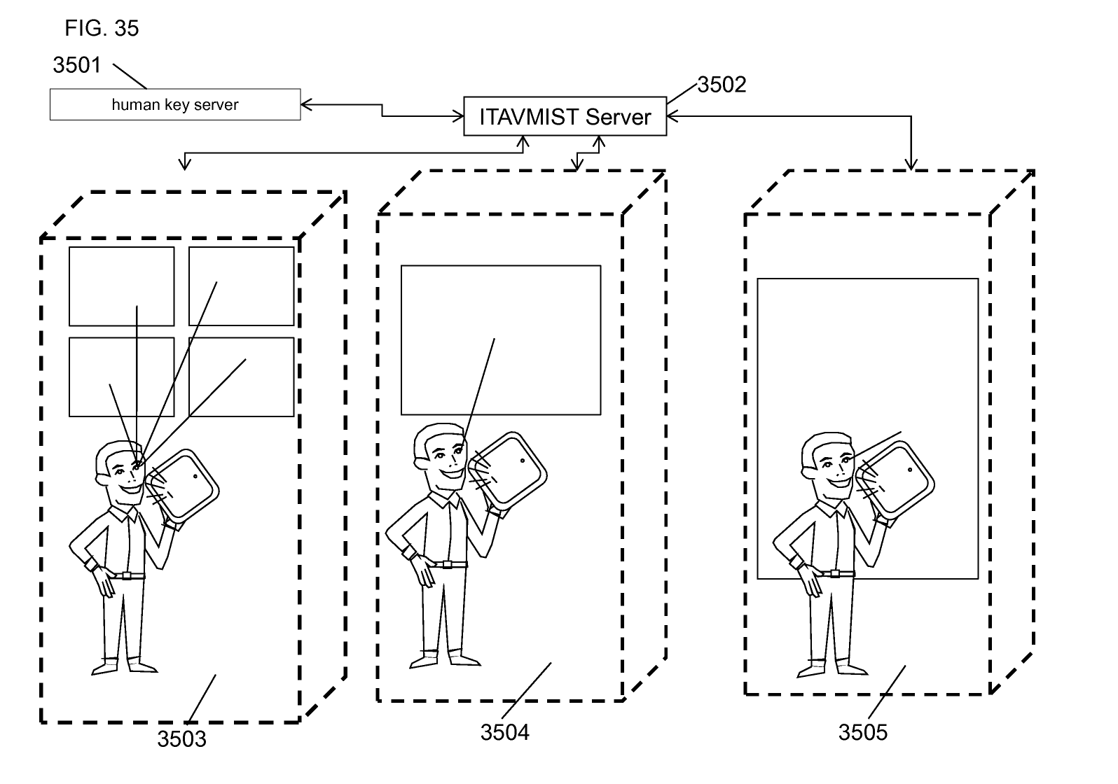

FIG. 35 illustrates an Illumination Transformer Audio Video Manager Interactive Server Transmitter (ITAVMIST) multiple people using multiple different size screens for viewing in their own zone method. A human key server 3501 and ITAVMIST server 3502 provide multiple different size screens for viewing in a plurality of zones 3503, 3504, and 3505.

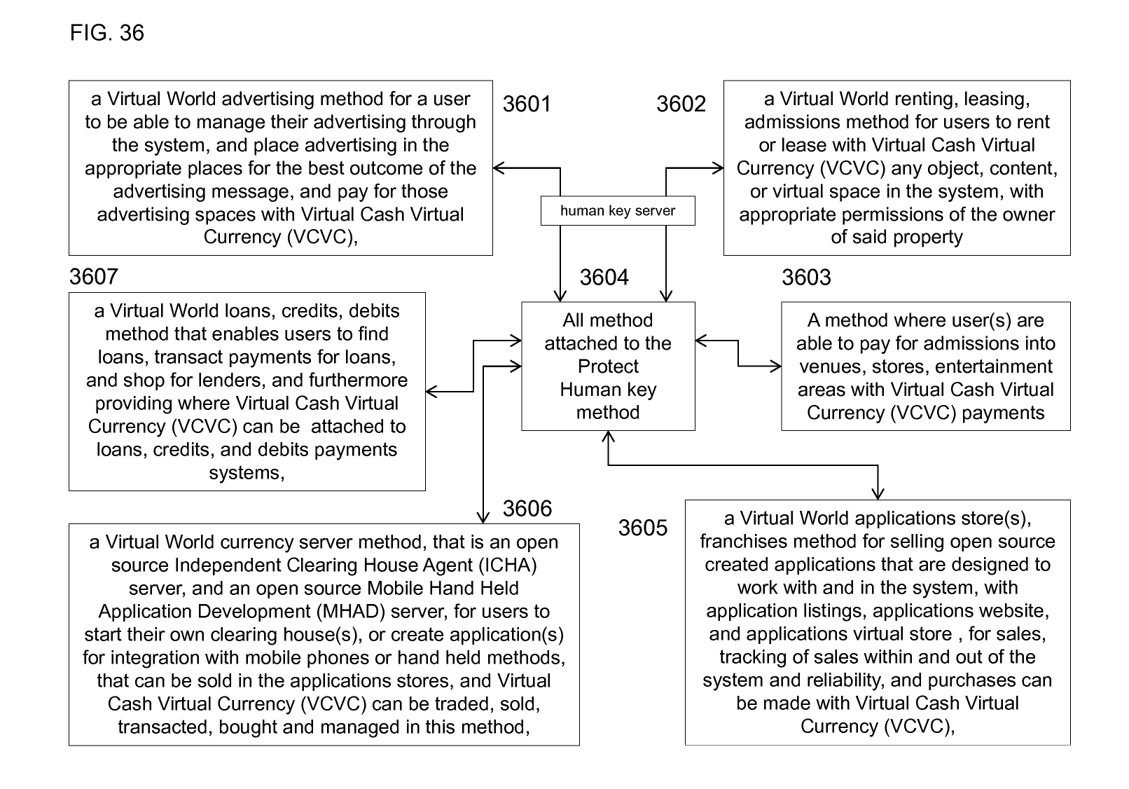

FIG. 36 illustrates advertising, renting, loans, currency, admissions, and franchise Virtual Cash method. A Virtual World advertising method for a user to be able to manage their advertising through the system, and place advertising in the appropriate places for the best outcome of the advertising message, and pay for those advertising spaces with virtual cash virtual currency (VCVC) 3601. A Virtual World renting, leasing, admissions method for users to rent or lease with virtual cash virtual currency (VCVC) any object, content, or virtual space in the system, with appropriate permissions of the owner of said property 3602. A method where user(s) are able to pay for admissions into venues, stores, entertainment areas with virtual cash virtual currency (VCVC) payments 3603. A Virtual World applications store(s), franchises method for selling open source created applications that are designed to work with and in the system, with application listings, applications website, and applications virtual store, for sales, tracking of sales within and out of the system and reliability, and purchases can be made with virtual cash virtual currency (VCVC) 3605. A Virtual World currency server method, that is an open source Independent Clearing House Agent (ICHA) server, and an open source Mobile Hand Held Application Development (MHAD) server, for users to start their own clearing house(s), or create application(s) for integration with mobile phones or hand held methods, that can be sold in the applications stores, and virtual cash virtual currency (VCVC) can be traded, sold, transacted, bought and managed in this method 3606. A Virtual World loans, credits, debits method that enables users to find loans, transact payments for loans, and shop for lenders, and furthermore providing where virtual cash virtual currency (VCVC) can be attached to loans, credits, and debits payments systems 3607. All method attached to the Protect Human key method 3604.

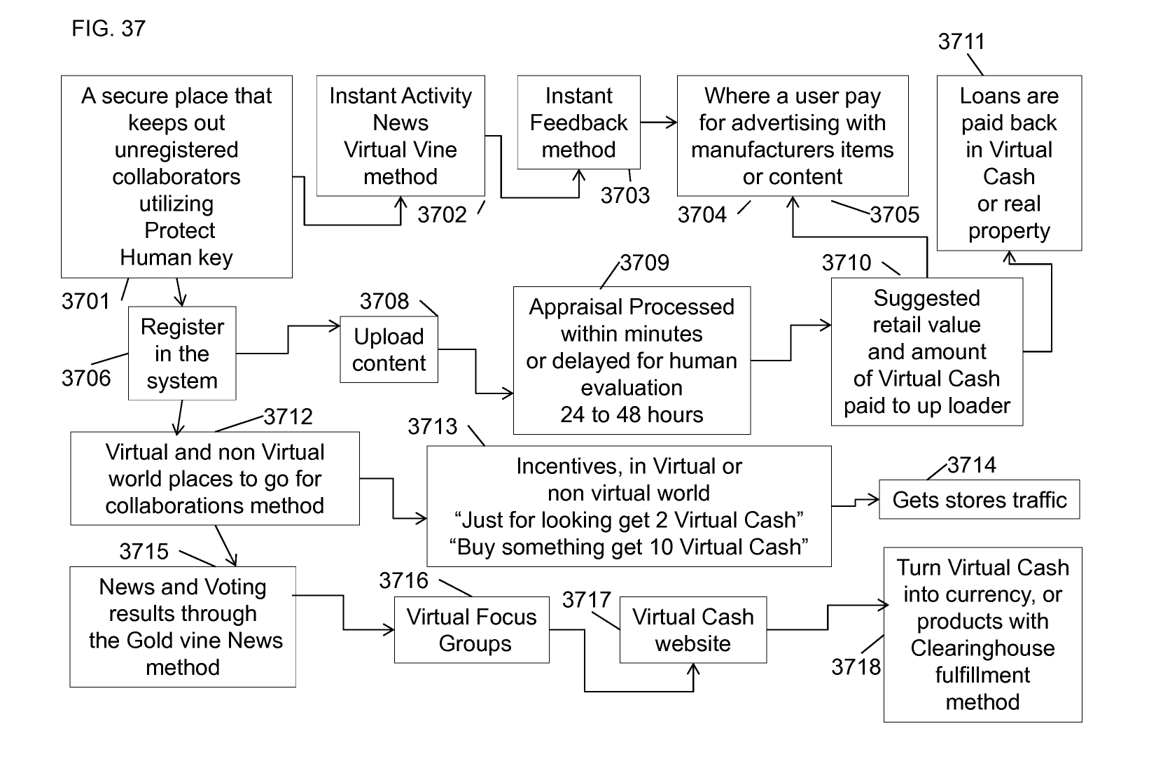

FIG. 37 illustrates a Virtual News, Promotions, and Advertising in Virtual Cash method. A secure place that keeps out unregistered collaborators utilizing Protect Human key 3701 comprising: instant Activity News Virtual Vine method 3702; instant feedback 3703 where a user pays for advertising with manufactures items or content 3705. A user registers in the system 3706, uploads content 3708, an appraisal is processed within minutes or delayed for human evaluation 3709. A suggested retail value and amount of virtual cash is paid to the uploader 3710. Virtual and non-virtual world places to do for collaborations are provided 3712. Incentives are provided 3713 to get stores traffic 3714. New and voting results are reported 3715 using virtual focus groups 3716 and virtual cash websites 3717 to turn virtual cash into currency or products for clearing house fulfillment 3718.

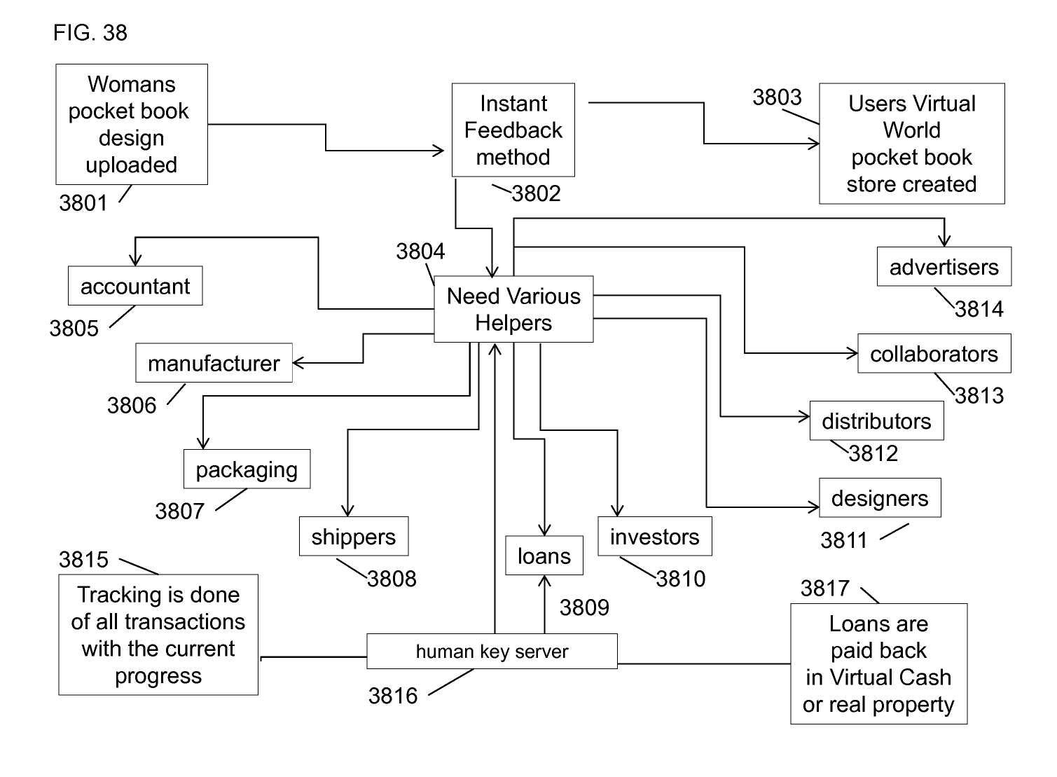

FIG. 38 illustrates a Virtual Stores, Collaborations, and Virtual Loans in Virtual Cash. A woman's pocket book design is uploaded 3801. Instant feedback is provided 3801 and a store is created 3803. Various helpers 3804 are provided such as: accountants 3805, manufacturers 3806, packaging 3807, shippers 3808, loans 3809, investors 3810, designers 3811, distributors 3812, collaborators 3813, and advertisers 3814. The human key server 3816 identifiers and authenticates the various helpers. Tracking is done of all transactions with the current progress 3815 and loans are paid back in virtual cash or real property.

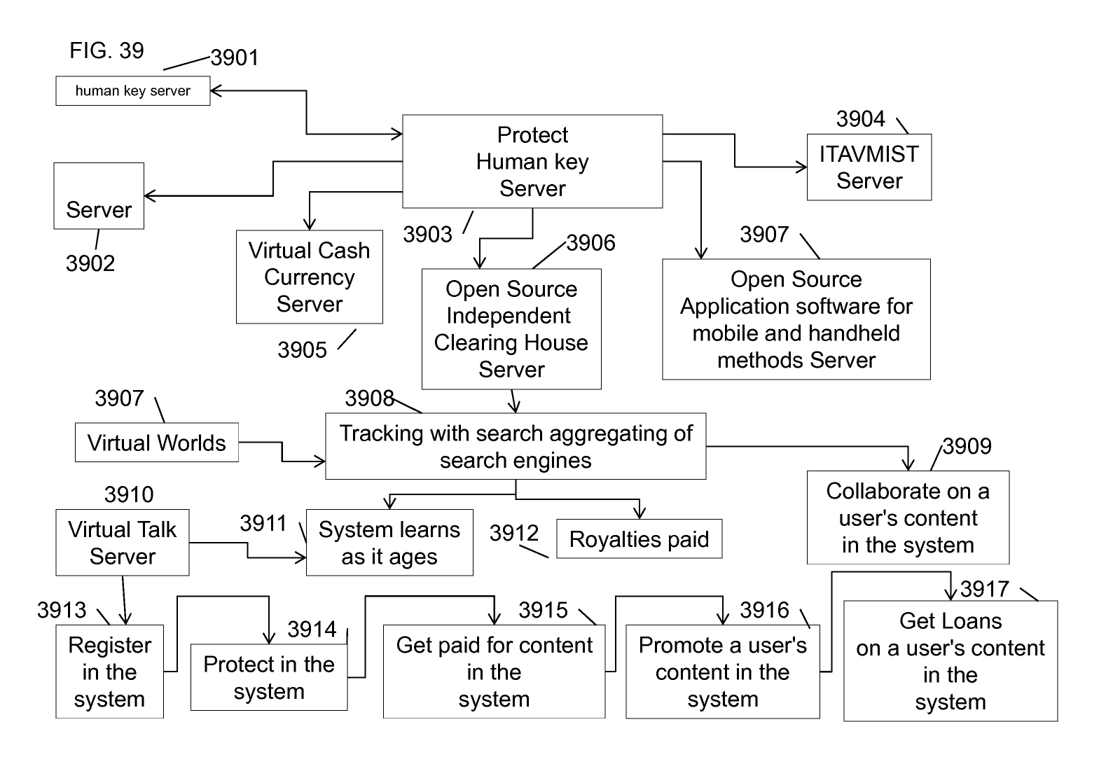

FIG. 39 shows a Protect, ITAVMIST, Clearing House, Applications, and Virtual Cash method. A human key server 3901, server 3902, ITAVMIST server 3904, and virtual cash server 3905 communicate with the protect server 3903. Open source application software for mobile and handheld servers is provided 3907. An Open Source Independent Clearing House Server 3906 tracks with search aggregating of search engines 3908 and virtual worlds 3907, collaboration on a user's content in the system 3909, royalties paid 3912. The system learns as it ages 3911 and communicates with a virtual talk server 3910. When a user registers 3913 in the protect system 3914, they get paid for content in the system 3915 their content is promoted 3916, and they can get loans based on their content 3917.

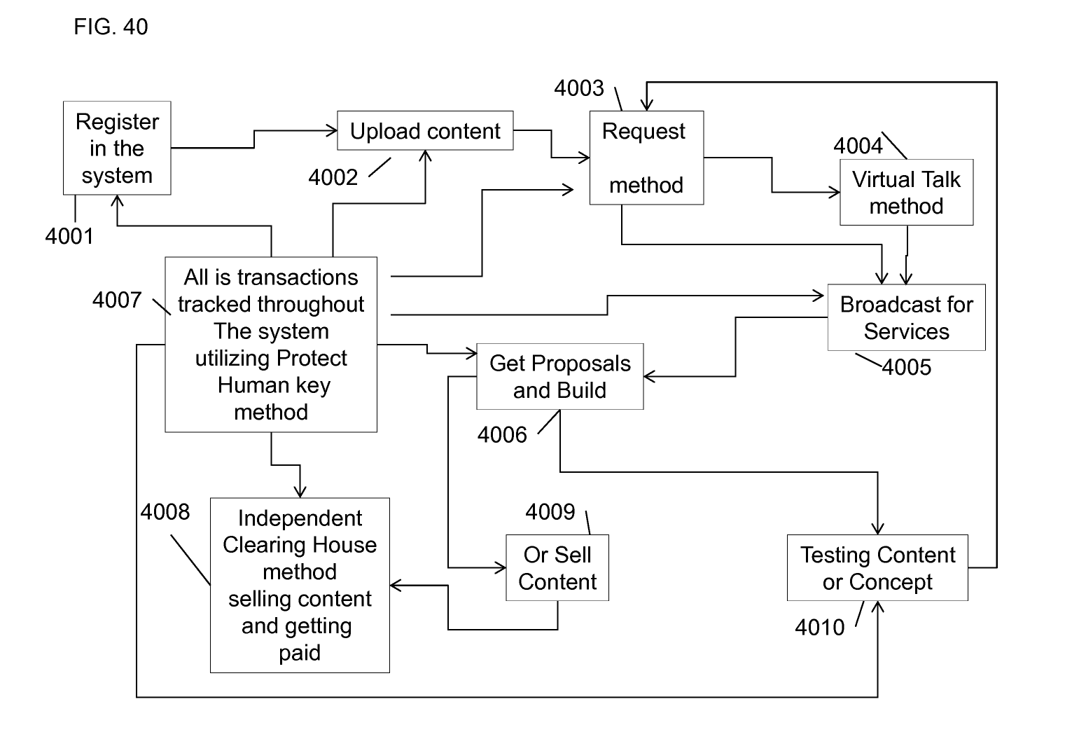

FIG. 40 illustrates a Virtual World Content handling processor method. A user first registers in the system 4001 and uploads content 4002. A request is made 4003 via the virtual talk server 4004 and a broadcast is made of the content 4005. Proposals are solicited and built 4006 or the content is sold 4009. All transactions are tracked throughout the system uses the human key 4007. An independent clearinghouse is provided to sell content and pay the user 4008. Testing of a concept or content can also be provided 4010.

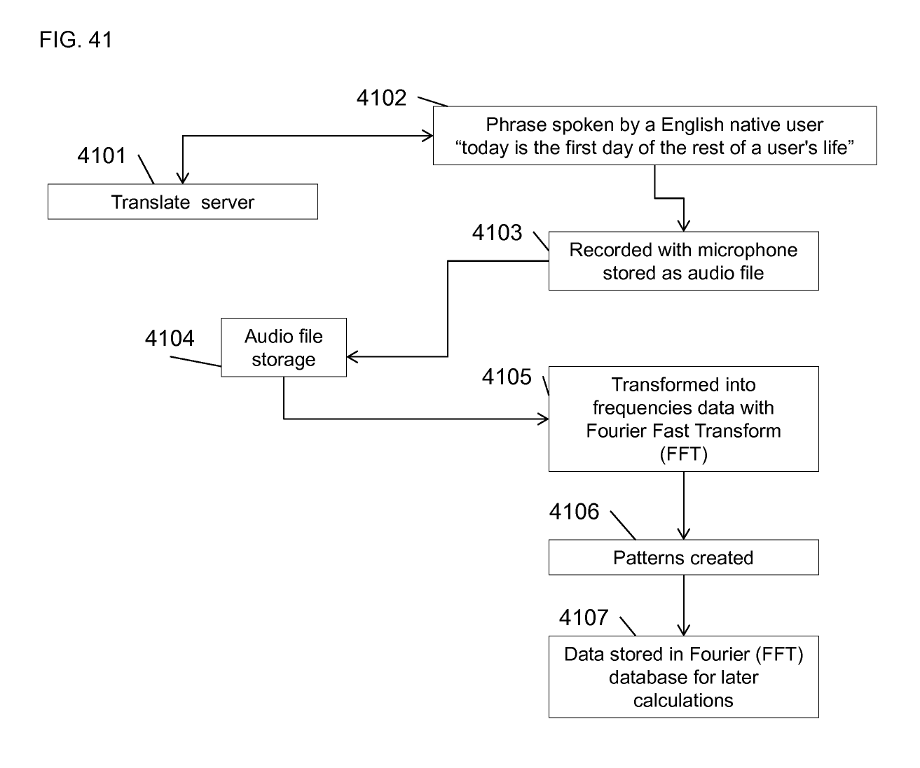

FIG. 41 illustrates the Translate Fourier transformation method taught by the present invention. A translation server 4101 takes a spoken phrase 4102 recorded with a microphone and stored 4103 as an audio file 4104 and transforms it into frequencies date using a Fourier fast transform (FFT) 4105. Patterns are created 4106 and data is stored in FFT for later calculations 4107.

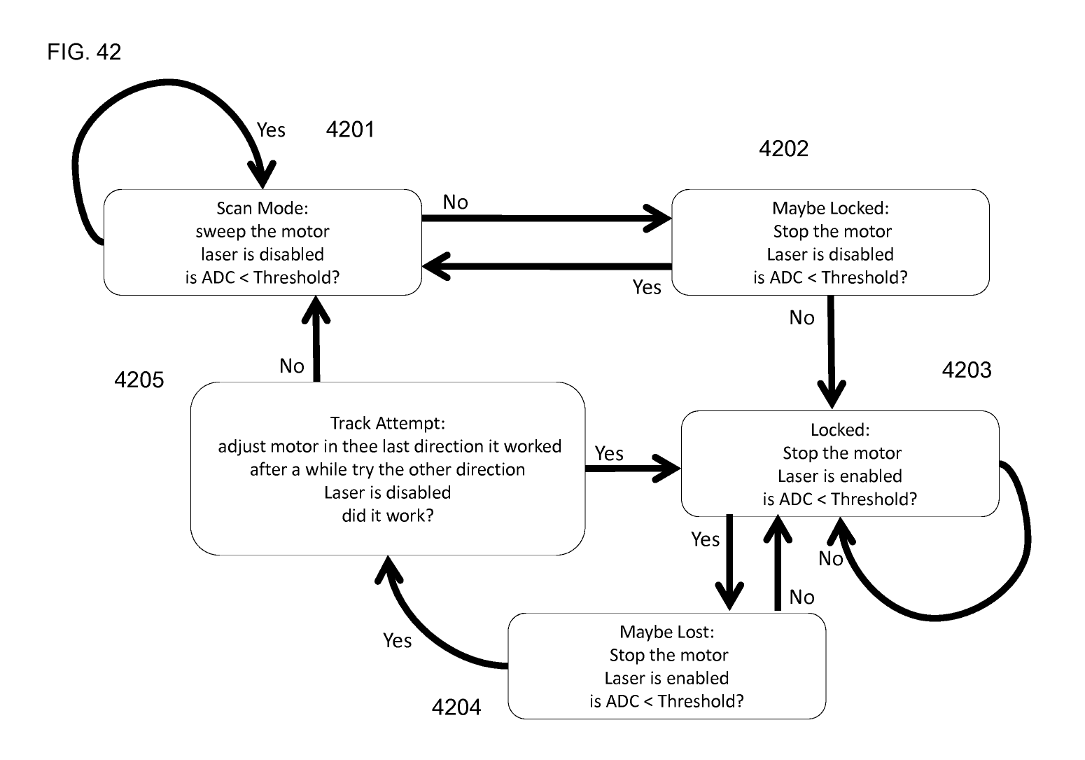

FIG. 42 shows the Laser Transmitter Receiver transmit scanning method of the present invention. The first step is to determine if the laser is enabled and the motor is swept 4201. The next step is to determine if the motor is locked 4202 and the motor is stopped. If the laser is locked, the motor is stopped 4203 and the laser is check to see if it is lost 4204. A track attempt is then made to adjust the motor in the last direction it worked 4205. Software state machine, used for transmitter scanning, using a Moore machine to control the actions of the transmitter, the diagram above outlines its behavior.

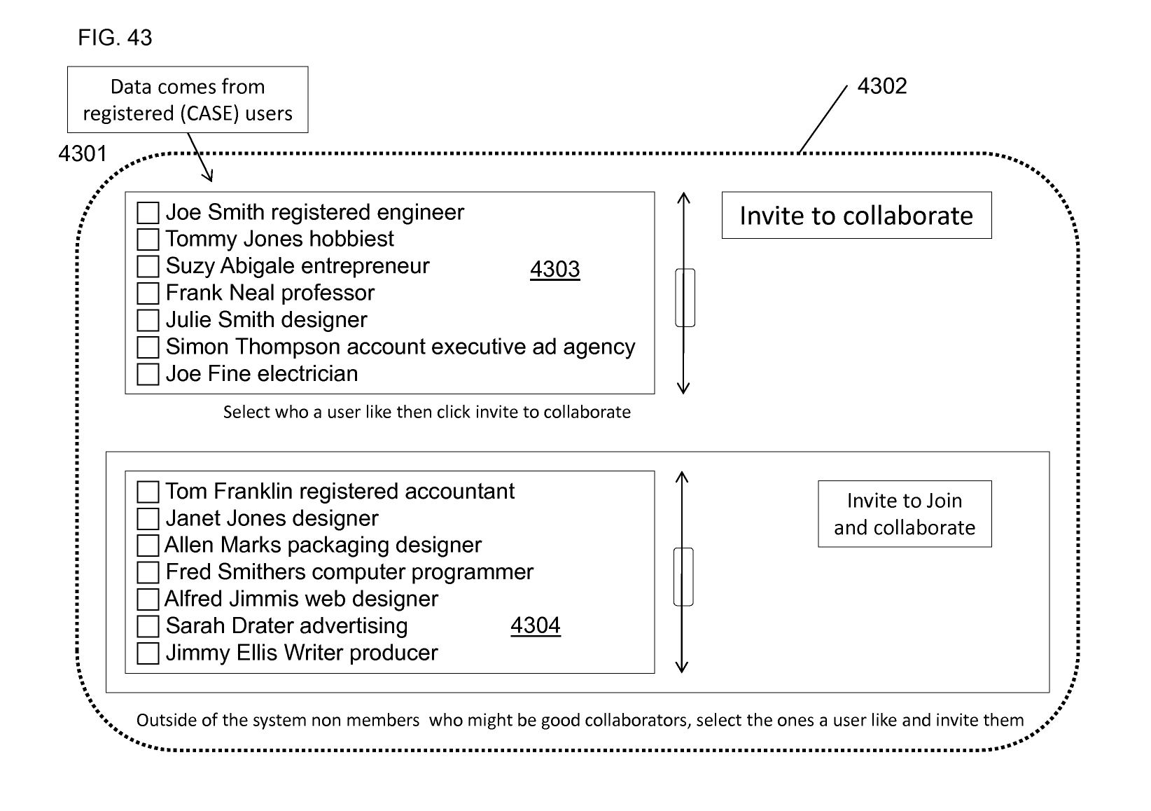

FIG. 43 illustrates a Collaborate Search Engine (CASE) method where data comes from registered users 4301. A display 4302 allows a user to select other users in the system 4303 to invite to collaborate or users outside the system whose data comes from registered Request users and/or aggregated from internet to invite to collaborate 4304.

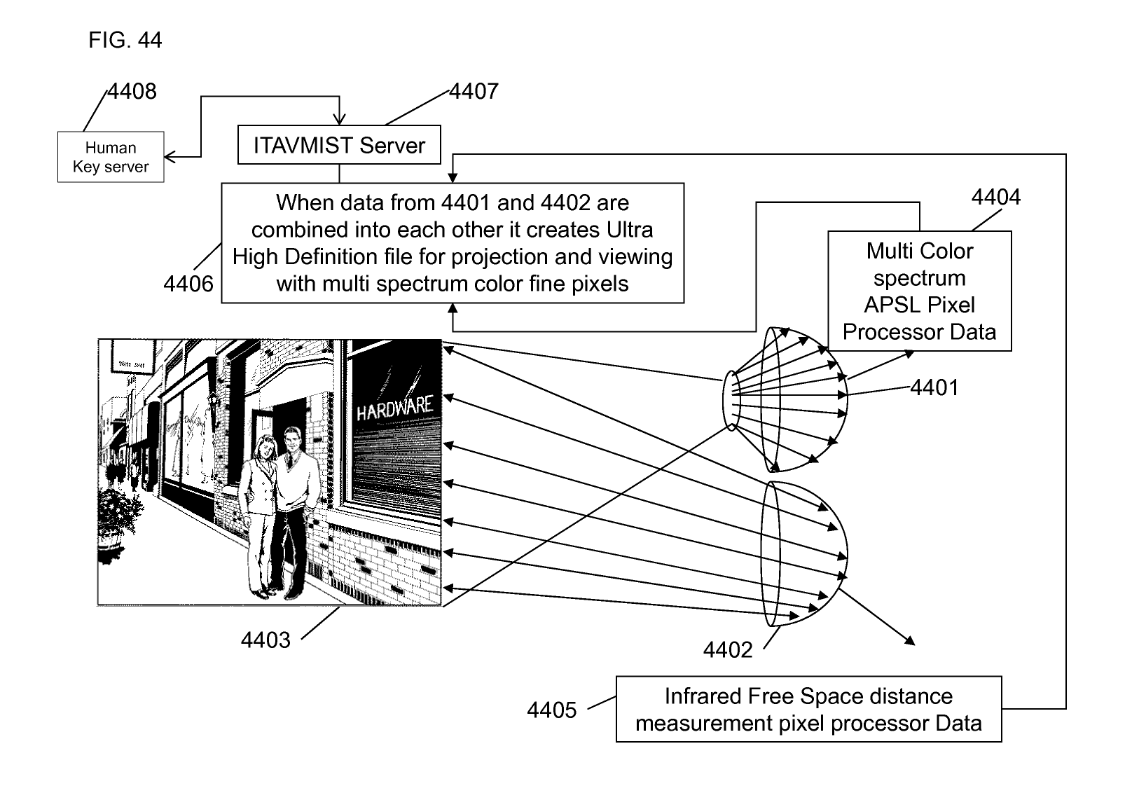

FIG. 44 is an illustration representative showing the Illumination Transformer Audio Video Manager Interactive Server Transmitter (ITAVMIST-IL-UHD) Ultra High Definition Multi Spectrum Camera Device and further comprising a method and device which is an active-pixel sensor (APS) device that includes a plurality of curved bowl shape sensors 4401 and 4402 with active-pixel image sensors that have sensitivity to wide spectral gamut of colors at nano-scale each combined with position related active pixel sensor imager (APSI) infrared distance measurement recording device, for recording of distance to the nano-pixel object, for processing in determining ultra-high resolution vision, and further comprising where distance to object viewed at upper edge of bowl active-pixel image sensor is always the same as the distance to object viewed center lower edge of active-pixel image sensor bowl, for creating and recording ultra-high definition images and video.

The curved bowl shape sensors 4401 and 4402 record an object 4403. A multi-color spectrum APSL Pixel Processor 4404 processes the data and the recoding is stored as a file in a database for storage 4405. In step 4406, the data from 4401 and 4402 are combined into each other to create an Ultra High Definition file for projection and viewing with multi spectrum color fine pixels 4406. Each pixel from the shape sensor in 4401 is related to a pixel from the shape sensor in 4402. The recording is authenticated and identified by the human key server 4408 and managed by the ITAVMIST Server 4407.

Moreover, other implementations of the invention will be apparent to those skilled in the art from consideration of the specification and practice of the invention disclosed herein. Various aspects and components of the described embodiments may be used singly or in any combination in the computerized content filtering system. It is intended that the specification and examples be considered as exemplary only, with a true scope and spirit of the invention being indicated by the following claims.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. An method for connecting a human key identification to objects and content or identification, tracking, delivery, advertising, and marketing executed by a computer comprising the steps of:
providing an Independent Clearing House Agent (ICHA) server;
providing a human key server;
connecting the human key server to a translation server and universal virtual world (UVW) server;
connecting a virtual world airport (V WA) server to a development server which in turn communicates with an illumination transformer audio video manager interactive server transmitter (ITAVMIST) which communicates with a virtual cash virtual currency (VCVC) server.

2. The method of claim 1 further comprising the steps of:
using a laptop or cam to provide input to a first manager server which communicates with a time stamp back up media server and a cluster of storage servers that have access to the human key server and digital fingerprint storage servers for verification;
providing a cam or computer accessing the human key server which in turn accesses a media server which accesses a first video server stream manager which in turn sends information to a time stamp server and certifier which is backed up a stored;
validating a digital fingerprint by providing access to the first video server stream manager to a digital storage encryption server which validates a digital fingerprint form stored prints and encrypted prints.

3. The method of claim 1 further comprising the steps of:
providing a laptop or mobile device communicating with a human key server;
using a human key in a virtual and non-virtual world is illustrated;
beginning an Intellectual Property Protection campaign begins;
providing an authentication and identification by the human key by accessing protection databases;
upon beginning a campaign, information databases are accessed and a conversion of the campaign into a numerical valuation begins;
calculating who is needed value, time frame, value, a fair value share for investment by investor value, individual or group buying selling value, estimated ROI value, request for pricing value and buying, selling participation;
storing this numerical determination;
beginning implementation of the campaign.

4. The method of claim 1 further comprising the steps of:
recording a 360 degree view, or hearing of any object, chats, or sounds in the Virtual World;
calculating and paying matching contributions, and investments, and used for advertisements, and promotions, for further gains in raising funds throughout the system;
creating, managing, and documenting, and where people can play sports, create teams, leagues, make schedules, and manage all sporting activities in the Virtual World;
attaching all devices are attached to the human key device for tracking, security, and identification;
making group transactions utilizing the virtual cash virtual currency (VCVC), with transactions through the Independent Clearing House device system;
uploading the content to the main server for storage, transformation, and distribution;
providing storage available in a vault a user has attached to their human key, for later viewing, marketing, advertising, entertainment, royalties, or interest paid by an entity, for use and storage in another user's account, all data and transactions.

5. The method of claim 1 further comprising the steps of:
creating virtual vouchers, coupons, rebates, and discounts transacted with virtual cash virtual currency (VCVC) devices;
simulating a Virtual World IPO, going public, stock, options and derivative trading, buying multiple ideas;
trading in a blind pool of ideas, for what if scenarios, entertainment, planning and education.

6. The method of claim 1 further comprising the steps of:
Providing for the uploading of various file types such as images, video, text, scans, audio, or forms;
selecting from a list the type of property being entered into the system for protection;
providing access to video, text, documents, images, and audio while allowing the user to edit, or send information or payment within the system for various transactions;
providing a real estate showcase that provides images or video of a property and a written description with links to additional video, audio, images, and text in addition to providing the ability to purchase the property;
providing a business prospectus for review by a user with links to additional video, audio, images, and text in addition to providing the ability to purchase the property.

7. The method of claim 1 further comprising the steps of:
searching for news, articles, and content pricing;
uploading, protecting, marketing, and conducting bank transactions or use by the included smart intelligent agent device for devices, or other people to make transactions;
attached all actions to the human key device; and
utilizing the virtual cash virtual currency (VCVC) for news, articles, and content, with a human management.

8. The method of claim 1 further comprising the steps of:
tracking, recording, and listing device, with a transaction listing directory, of all intellectual property, content, products, goods or services, for the purpose of registered users to be able to search, use graphs, and learn from, pertaining to all transactions in the system, that have permissions, that are public;
connecting to the virtual cash virtual currency (VCVC) device and human key server;
conducting transactions in accredited independent clearing houses;
limiting any private transactions to be viewed in this directory, for either a period of time or until user deems it necessary to make it public knowledge;
providing a Virtual World Shared Payment platform device, for a plurality of users utilizing virtual cash virtual currency (VCVC) that is transacted in the virtual world and traded in independent clearing houses, not associated with Virtual World;
providing an array of information where a virtual comparison of property values, between a plurality of properties, can be created graphically, and geographic location within the virtual world, or outside can be compared, along with searches for who are the neighbors, who is buying the properties, what is the property close to, income values aggregated historically, health risks, weather, taxes, and any other values about properties, that assist a user in making decisions;
paying bills with virtual cash virtual currency (VCVC);
sell, auction or trade virtual cash virtual currency (VCVC) outside of the system, in an independent clearing house, and where when the sale is finalized, the pre-determined royalty, commission, or fee is automatically charged against the sale and the real world royalty or commission is deposited into the Virtual World real bank account, and the exact amount is deposited into the sellers, auctioneers, or traders virtual cash virtual currency (VCVC) virtual bank account.

9. The method of claim 1 further comprising the steps of:
recording video and audio into a laptop, smartphone, tablet computer, or other electronic device;
speaking a phrase;
matching the spoken phrase to a previously recorded phrase;
providing a human key server that verifies the phrase and provides confirmation;
enabling a successfully logged so a user can use the computer or service.

10. The method of claim 1 further comprising the steps of:
Providing a 3D camera recording a person and background images;
determining that an object being viewed by cam is a 3 dimensional object before verification and during identification registration;
comparing the cams results and analyzing them in an overlay pixel pattern analysis method;
calculating the position of forward focused object;
calculating the position and depth of background object focused;
calculating the difference between the forward focused object and the background object;
the difference determines a 3D preliminary security decision;
creating an Audio voice print;
determining the distance by audio voiceprint;
comparing the position of forward focused object to the Distance is determined by audio voiceprint;
making a final security decision.

11. The method of claim 10 further comprising the steps of:
collecting 3D auto and video;
determining whether the user is who was registered in system with a bank or other money holding system;
providing verification of 3D audio, 3D video, and phrase analysis.

12. The method of claim 10 further comprising the steps of:
providing that applications that are created by outside creators, have virtual cash virtual currency (VCVC) connections, and are charged a royalty fee for sales of applications;
providing that properties built in the virtual cash virtual currency (VCVC) world have valuations attached to a human key, and valuations of the properties are updated periodically as traffic, interest, and viewers increase around that properties area, and at least one spot of the property, is required to be allocated for promotions and advertising;
purchasing content, properties, objects, or services from a user that is registered with a royalty agreement in the system, and that purchase, gives the purchaser an equal amount of virtual cash virtual currency (VCVC) to the actual price paid at an independent clearing house;
using the virtual cash virtual currency (VCVC) for all promotions and advertising;
paying virtual cash virtual currency (VCVC) to a registered user for any content added to the content bank, idea bank, or intellectual property bank, automatic promotions are added to the payment package for promoting sales, collaborations, reviews, and assistance with services, manufacturing, further promotions, editing, and packaging, transactions;
attaching all methods and devices are attached to the human key for tracking, security, and identification.

12. The method of claim 11 further comprising the steps of:
providing valuation of content uploaded into the system, and is displayed when content is stored, so that a work of art, writing, photograph, movie, video, song, idea gets a certain amount of virtual cash virtual currency (VCVC) when it is added to the system;
attaching a certain amount of royalties to the content, and attached to the human key for security, identification, tracking, and transactions;
providing that all content, and contracts dependent upon content are secured, attached, and signed by the user's human key, and cosigned by the virtual cash virtual currency (VCVC) Intelligent Virtual Private Currency Server node system device administrator human key.

13. The method of claim 12 further comprising the steps of:
providing an applications store device for open source applications related to the virtual cash virtual currency (VCVC) virtual world device, for use with purchases made utilizing virtual cash virtual currency (VCVC) virtual world currency, in a virtual world or non virtual world, where a user can list, package, protect, request a sponsor, collaboration, sale or investor, market with shared advertising and revenue or promote is also taught by the present invention;
conducting Virtual World Payments, Currency, Money, Credit, Debit, Buying, Selling, protection, Privacy, Trading, and Barter can be done within a no charge to join, or a fee to join, system, where even smaller percentage is paid for rights on goods related to content indefinitely;
paying a percentage of the royalties when content is sold to the system operators, and where a larger percentage if the sales royalties are a onetime rights sale, and smaller percentage is paid to the systems operators if royalty rights are charged for every sale of goods related to the content for a longer time;
providing a virtual world bot agent for making automatic deals involving content in virtual world with attached human key universal wallet, that can work in any virtual world, or non virtual world wide web, buy additional promotion with virtual cash virtual currency (VCVC) virtual world currency where a virtual world transaction exchange, and management area for pricing content submitted, is provided in the system, and a universal tool kit for making designs for packaging, and creating virtual world contracts, is included in.

14. The method of claim 13 further comprising the steps of:
providing a Virtual World transaction exchange device attached to the human key device, for users to create, manage, and market transactions in the virtual world is also taught;
uploading transactions to the real world and deals are controlled by users, and the system gets only a percentage of the deal made, unless another agreement is recorded for the transaction by the user(s) in the system;
providing a Virtual World witness device attached to the human key device, for a user to have an authorized record for, check writing, check cashing, agreements, contracts, proposals, signing of documents, legal and medical transactions, procedure and records;
providing a Virtual World rights management attached to the human key for content management of promotions, marketing, and collaboration needs, and rights can be paid with virtual cash virtual currency (VCVC);
providing a Virtual World Resume device attached to the human key device for users to manage, upload, create, store, and distribute their resumes in video, text, image, or 3D virtual world projection, to any spatial point target, or virtual world space;
providing a Virtual World Future Goods or Services device attached to a human key where a user(s) can list, shop and trade future user goods, services, and/or skills at a specified future time, for financial help, loans, virtual cash virtual currency (VCVC), medical services, or any variation of help;
providing a Virtual World try out product device attached to the human key device for users to be able to try out products, services, or ideas, in a user's own space, the virtual world, or in real world stores, or at point of purchase, or point of display, and additionally a method and device for a user to get virtual cash virtual currency (VCVC) for trying out things in the Virtual World or real world.

14. The method of claim 1 further comprising the steps of:
speaking into electronic device equipped with a microphone and 3D cameras;
targeting the tip of the nose of a speaker;
performing pattern matching and processor tests and routines and Creates pixel color band array converted to position numbers;
creating wavelength data into encrypted numbers, stored in database and then de-encrypted for identification;
comparing the final number with “wavelength Fourier Wave Form”, “3D Analysis”, “Audio Fingerprint”, “and Video Fingerprint”;
obtaining a match for identification;

15. The method of claim 1 further comprising the steps of:
providing an incentive device for utilizing points, and discounts with scanning, capabilities for matching with products can be incorporated into the method;
scanning to see if the product has a rebate, discount, coupon, or Virtual Cash incentive that can be used in the current purchase being considered;
connecting to the human key for identification;
scanning the product with a mobile phone, hand held, or any device enabled with product registration scanning capabilities, to see the discount, other offers;
purchasing the product;
receiving the incentive, discount, coupon, or information; and
charging the purchase to the user's human key, or the user is the card account.

15. The method of claim 1 further comprising the steps of:
speaking to create an audio voice print;
streaming video images and creates video print;
converting video data to color band calculated pattern to numbers;
registering the numbers in a database with special interpolation algorithm as a digital fingerprint;
recording a phrase;
creating an audio voiceprint login;
streaming video images;
creates a video print;
converting video data to color band calculated pattern to numbers; and
comparing converted data to a database of pre-registered audio video prints digital fingerprint.

16. The method of claim 1 further comprising the steps of:
Transforming an ITAVMIST virtual free space projection display into a multi touch screen free space display device is taught by the present invention;
aggregating the changes in intersecting infrared laser points a by the ITAVMIST device'
recording, processing, transforming, and creating the information needed for further tracking the touched areas in real time;
using the touched areas as a control device for the free space display utilizing the transformed pixel points affected;
touching the free space pixel area and in applications designed for that purpose, such as scrolling through a gallery of images in free space by just touching the free space projection and sliding your finger along a path, to scroll to the next image.

17. The method of claim 1 further comprising the steps of:
Using a computer or mobile electronic device to access the human key server for validation and identification;
recording anything and it will be attached to a human key identity;
sending the recording;
storing the recording in the system's human key repository under their ID account;
creating text from images, music or video files;
setting the files as public or private as a verified item for people to access and use

18. The method of claim 1 further comprising the steps of:
placing sponsor ads in search engines, press releases, campaigns videos, blogs, articles, websites, in print media, magazines, books, billboards, coupon books or mobile applications or emails;
using the human key for place the ads, a secure payment system, tracking and advertisement creation and placement system is created;
providing a rating system where a user, using the same audio and video authentication process, access the system where certified and authenticated ratings can be provided, stored, and utilized.

19. The method of claim 18 further comprising the steps of:
providing a plurality of colored shields corresponding to the level of authentication and certification of a user as well as providing an indicator if they are open or close to accepting licensing of their property;
the first color of the shield would identify if a user is registered and identified,
a second color of the shield who signal that a user is registered, identified, and authenticated,
a third shield color would signal that a user was registered, identified, authenticated, and certified; and
a colored bar associated with the shield image would use a first color to signal a user is open to licensing and a second color to signal a user is closed to licensing.

20. The method of claim 1 further comprising the steps of:
opening a source clearing house for anyone to create an auction, website, virtual world place, store, directory, listing area clearing house with ability to charge a fee for services rendered in selling properties, real estate, content, objects, services;
converting real world sales into virtual cash virtual currency (VCVC) virtual world currency, automatically at the moment of purchase and payment;
creating applications to work outside and within the area of operations and is connected to the human key server 1 for promotion, traffic building, gaming, store purchases, sales, packaging, marketing, with content distribution, and delivery network from virtual cash virtual currency (VCVC) server node;
providing a semantic evaluation for a content provider to give reminders of when to get an editor, service person, professional marketer, publisher, music promoter, or any other expert for promotions of a user's content, or providing remind anything recommendations connected through the request anything system and device for assistance after a user's content is uploaded and secured with the human key.

21. The method of claim 1 further comprising the steps of:
tracking ownership of content, objects, and virtual representations of humans in a virtual world that follows through online or offline with transfer capabilities;
attaching virtual cash virtual currency (VCVC) values to objects to be used as virtual currency in virtual worlds;
using virtual cash virtual currency (VCVC) in a virtual world with medical documents and information attached to a human key for security and privacy for use in a virtual doctor's office 1502 is connected to the human key server;
providing connections to virtual world showroom or store that connect to the human key for advertisements;
tracking and identification using the human key currency price negotiator device for pricing cost of advertisements as related to positioning within the network, and amounts of clicks, pay per view, or group viewing events aggregations.

22. The method of claim 1 further comprising the steps of:
recording a favorite key phrase while nose on target cross hair;
recording a 30-60 second video;
extracting images and audio for analysis;
conducting a Fourier image analysis and storage in same field as the key phrase;
storing until a person wants to be identified in the human key server;
transforms the key phrase to a typed phrase;
using a database for storage of the typed key phrase later used for initial search to narrow the search array;
using verification of the key phrase.

23. The method of claim 1 further comprising the steps of:
showing yourself and saying a phrase attached to a human key server 1902;
attaching a virtual world credit score to a human key, that lets other users know what a user's credit score;
attaching a virtual world bank account attached to a human key for transactions with virtual cash virtual currency (VCVC) in the virtual world, that have to be converted by a sale of content, objects, virtual real estate or other tangible assets not inside the virtual world, but independent outside the virtual cash virtual currency (VCVC) environment, in an independent virtual cash virtual currency (VCVC) clearing house, for sale of virtual world or non virtual world content, objects, royalties, properties, and collaboration rights in a virtual world and in a real world, with virtual buying, selling and lending of objects, virtual cash virtual currency (VCVC) and content through the clearing house.

24. The method of claim 1 further comprising the steps of:
providing an Illumination Transformer Audio Video Manager Interactive Server Transmitter (ITAVMIST);
using the ITAVMIST server 2401 to create a property;
creating a 3D image of the object to be protected;
attaching a user's identity using the human key server;
including a user's creation in a license catalogue;
depositing licensing fees in a user's bank;
offering deals related to outright purchase or exclusive rights can be proposed and approved only by a user;
storing all licensing as content;
presenting relevant licensing as appropriate search terms are presented to create opportunities for potential licensees.

25. The method of claim 24 further comprising the steps of:
scanning facial area;
determining distance for topographic surface of the face;
scanning facial area for 3D mapping utilizing sonic and infrared scanning;
scanning distance data;
recreating the facial area in white plasma the 3D topographic of the face for projection of colors.

26. The method of claim 24 further comprising the steps of:
creating Free Space Stereo Audio from infrared laser light;
converting the infrared laser light to audio waves at spatial point target captured by the ITAVMIST server and human key server;
creating free Space 2D or 3D Video from infrared lasers, and visible light lasers in dimensional space.

27. The method of claim 24 further comprising the steps of:
providing a person speaking in front of cam with microphone and laser;
using an Infrared laser system to measure distances on a speaker's face;
sending the data to the ITAVMIST server;
determining whether a user is registered with a bank or other money holding system;
recording voice commands;
acting on voice commends with respect to the bank or other money holding system.

28. The method of claim 1 further comprising the steps of:
providing a Virtual World energy bank;
uploading content;
protecting content automatically;
providing a virtual cash virtual currency (VCVC) appraisal and payment for the users uploaded content directly into their content bank;
providing collaborations to make the content better or for packaging, marketing, opinions from other users, then the user can test the interest in the content, and sell, license, rent, or lease;
selling the content through an independent outside clearing house with only a small percentage of the revenue generated going back to the system; and
depositing an equal amount to the commission being deposited in (VCVC) in the user who approved the generated revenues virtual cash virtual currency (VCVC) bank account.

28. The method of claim 24 further comprising the steps of:
providing a human key server and ITAVMIST server connected to a recording device comprised of an IR Laser, and left and right cameras for recording a person;
determining a person's distance by IR laser of pixel points on selected facial pattern with nose as main focal point and values are created;
locating a human face in space;
determining whether an object being viewed by cam is a 3 dimensional human live object before verification and during identification registration;
locating a human face in space;
determining whether an object being viewed by cam is a 3 dimensional human live object before verification and during identification registration;
calculating all pixel values distances calibrated within facial surface area, omitting eyes area;
calculating position and depth of facial background object focused;
calculating position of forward focused object at the tip of nose;
asking a questions;
answering a question to provide an Audio voice print;
determining distance by audio voice print;
comparing distance values;
making a final security decision.

29. The method of claim 24 further comprising the steps of:
manage advertising;
placing advertising in the appropriate places for the best outcome of the advertising message;
paying for those advertising spaces with virtual cash virtual currency (VCVC);
renting or leasing with virtual cash virtual currency (VCVC) any object, content, or virtual space in the system, with appropriate permissions of the owner of said property;
paying for admissions into venues, stores, entertainment areas with virtual cash virtual currency (VCVC) payments;
selling open source created applications that are designed to work with and in the system, with application listings, applications website, and applications virtual store, for sales, tracking of sales within and out of the system and reliability, and purchases can be made with virtual cash virtual currency (VCVC);
providing an open source Independent Clearing House Agent (ICHA) server;
providing an open source Mobile Hand Held Application Development (MHAD) server, for users to start their own clearing house(s), or create application(s) for integration with mobile phones or hand held methods, that can be sold in the applications stores;
generating virtual cash virtual currency (VCVC) that can be traded, sold, transacted, bought or managed.

30. The method of claim 24 further comprising the steps of:
providing a secure place that keeps out unregistered collaborators;
paying for advertising with manufactures items or content;
registering in the system;
uploading content;
processing an appraisal within minutes or delayed for human evaluation;
generating a suggested retail value and paying that amount in virtual cash to the uploader;
providing virtual and non-virtual world places for collaborations;
providing incentives to get stores traffic;
reporting new and voting results are using virtual focus groups;
using virtual cash websites to turn virtual cash into currency or products for clearing house fulfillment.

31. The method of claim 1 further comprising the steps of:
uploading content;
making a request via a virtual talk server;
creating a broadcast of the content;
soliciting proposals for the content being offered for sale;
tracking all transactions throughout the system using the human key;
providing an independent clearinghouse to sell content and pay the user;
testing the marketability of a concept or content.

32. The method of claim 1 further comprising the steps of:
a translation server taking a spoken phrase recorded with a microphone and stored as an audio file;
transforms audio file into frequencies data using a Fourier fast transform (FFT);
patterns are created;
data is stored in FFT for later calculations.
